(19) United States
(12) Patent Application Publication
(10) Pub. No.: US 2025/0068900 A1
(43) Pub. Date: Feb. 27, 2025

(54) OUTPUT CIRCUIT FOR A VECTOR-BY-MATRIX MULTIPLICATION ARRAY

(71) Applicant: Silicon Storage Technology, Inc., San Jose, CA (US)

(72) Inventors: HIEU VAN TRAN, San Jose, CA (US); ANDREW KUNIL CHOE, San Jose, CA (US); HOA VU, Milpitas, CA (US)

(21) Appl. No.: 18/386,901

(22) Filed: Nov. 3, 2023

Related U.S. Application Data
(60) Provisional application No. 63/534,755, filed on Aug. 25, 2023.

(51) Int. Cl. G06N 3/065

(52) U.S. Cl. CPC G06N 3/065

(57) ABSTRACT

In one example, a system comprises a vector-by-matrix multiplication array comprising non-volatile memory cells arranged into rows and columns, a first set of columns storing W+ weights and a second set of columns storing W− weights; and an output circuit to receive a first current from a respective column in the first set of columns and a second current from a respective column in the second set of columns and to generate a first voltage and a second voltage, the output circuit comprising a first current-to-voltage converter comprising a first integration capacitor to provide the first voltage equal to an initial voltage minus a first discharge value due to the first current, and a second current-to-voltage converter comprising a second integration capacitor to provide the second voltage equal to the initial voltage minus a second discharge value due to the second current.

### PRIORITY CLAIM

This application claims priority to U.S. Provisional Patent Application No. 63/534,755, filed on Aug. 25, 2023, and titled “Output Circuit for Neural Network Array,” which is incorporated by reference herein.

### FIELD OF THE INVENTION

Numerous examples are disclosed of an output circuit and associated methods for a vector-by-matrix multiplication array.

### BACKGROUND OF THE INVENTION

Artificial neural networks mimic biological neural networks (the central nervous systems of animals, in particular the brain) and are used to estimate or approximate functions that can depend on a large number of inputs and are generally unknown. Artificial neural networks generally include layers of interconnected “neurons” which exchange messages between each other.

FIG. 1 illustrates an artificial neural network, where the circles represent the inputs or layers of neurons. The connections (called synapses) are represented by arrows and have numeric weights that can be tuned based on experience. This makes neural networks adaptive to inputs and capable of learning. Typically, neural networks include a layer of multiple inputs. There are typically one or more intermediate layers of neurons, and an output layer of neurons that provide the output of the neural network. The neurons at each level individually or collectively make a decision based on the received data from the synapses.

One of the major challenges in the development of artificial neural networks for high-performance information processing is a lack of adequate hardware technology. Indeed, practical neural networks rely on a very large number of synapses, enabling high connectivity between neurons, i.e., a very high computational parallelism. In principle, such complexity can be achieved with digital supercomputers or specialized graphics processing unit clusters. However, in addition to high cost, these approaches also suffer from mediocre energy efficiency as compared to biological networks, which consume much less energy primarily because they perform low-precision analog computation. CMOS analog circuits have been used for artificial neural networks, but most CMOS-implemented synapses have been too bulky given the high number of neurons and synapses.

Applicant previously disclosed an artificial (analog) neural network that utilizes one or more non-volatile memory arrays as the synapses in U.S. Patent Application Publication 2017/0337466A1, which is incorporated by reference. The non-volatile memory arrays operate as an analog neural memory and comprise non-volatile memory cells arranged in rows and columns. The neural network includes a first plurality of synapses configured to receive a first plurality of inputs and to generate therefrom a first plurality of outputs, and a first plurality of neurons configured to receive the first plurality of outputs. The first plurality of synapses includes a plurality of memory cells, wherein each of the memory cells includes spaced apart source and drain regions formed in a semiconductor substrate with a channel region extending there between, a floating gate disposed over and insulated from a first portion of the channel region and a non-floating gate disposed over and insulated from a second portion of the channel region. Each of the plurality of memory cells store a weight value corresponding to a number of electrons on the floating gate. The plurality of memory cells multiply the first plurality of inputs by the stored weight values to generate the first plurality of outputs.

### Non-Volatile Memory Cells

Non-volatile memories are well known. For example, U.S. Pat. No. 5,029,130 (“the '130 patent”), which is incorporated herein by reference, discloses an array of split gate non-volatile memory cells, which are a type of flash memory cells. Such a memory cell 210 is shown in FIG. 2. Each memory cell 210 includes source region 14 and drain region 16 formed in semiconductor substrate 12, with channel region 18 there between. Floating gate 20 is formed over and insulated from (and controls the conductivity of) a first portion of the channel region 18, and over a portion of the source region 14. Word line terminal 22 (which is typically coupled to a word line) has a first portion that is disposed over and insulated from (and controls the conductivity of) a second portion of the channel region 18, and a second portion that extends up and over the floating gate 20. The floating gate 20 and word line terminal 22 are insulated from the substrate 12 by a gate oxide. Bitline 24 is coupled to drain region 16.

Memory cell 210 is erased (where electrons are removed from the floating gate) by placing a high positive voltage on the word line terminal 22, which causes electrons on the floating gate 20 to tunnel through the intermediate insulation from the floating gate 20 to the word line terminal 22 via Fowler-Nordheim (FN) tunneling.

Memory cell 210 is programmed by source side injection (SSI) with hot electrons (where electrons are placed on the floating gate) by placing a positive voltage on the word line terminal 22, and a positive voltage on the source region 14. Electron current will flow from the drain region 16 towards the source region 14. The electrons will accelerate and become heated when they reach the gap between the word line terminal 22 and the floating gate 20. Some of the heated electrons will be injected through the gate oxide onto the floating gate 20 due to the attractive electrostatic force from the floating gate 20.

Memory cell 210 is read by placing positive read voltages on the drain region 16 and word line terminal 22 (which turns on the portion of the channel region 18 under the word line terminal). If the floating gate 20 is positively charged (i.e., erased of electrons), then the portion of the channel region 18 under the floating gate 20 is turned on as well, and current will flow across the channel region 18, which is sensed as the erased or “1” state. If the floating gate 20 is negatively charged (i.e., programmed with electrons), then the portion of the channel region under the floating gate 20 is mostly or entirely turned off, and current will not flow (or there will be little flow) across the channel region 18, which is sensed as the programmed or “0” state.

Table No. 1 depicts typical voltage and current ranges that can be applied to the terminals of memory cell 210 for performing read, erase, and program operations:

TABLE NO 1
Operation of Flash Memory Cell 210 of FIG. 2

| | | |
|---|---|---|
| WL | BL | SL |

| | | | | | | |
|---|---|---|---|---|---|---|
| Read | 2-3 | V | 0.6-2 | V | 0 | V |
| Erase | ~11-13 | V | 0 | V | 0 | V |
| Program | 1-2 | V | 10.5-3 | μA | 9-10 | V |

Other split gate memory cell configurations, which are other types of flash memory cells, are known. For example, FIG. 3 depicts a four-gate memory cell 310 comprising source region 14, drain region 16, floating gate 20 over a first portion of channel region 18, a select gate 22 (typically coupled to a word line, WL) over a second portion of the channel region 18, a control gate 28 over the floating gate 20, and an erase gate 30 over the source region 14. This configuration is described in U.S. Pat. No. 6,747,310, which is incorporated herein by reference for all purposes. Here, all gates are non-floating gates except floating gate 20, meaning that they are electrically connected or connectable to a voltage source. Programming is performed by heated electrons from the channel region 18 injecting themselves onto the floating gate 20. Erasing is performed by electrons tunneling from the floating gate 20 to the erase gate 30.

Table No. 2 depicts typical voltage and current ranges that can be applied to the terminals of memory cell 310 for performing read, erase, and program operations:

TABLE NO 2
Operation of Flash Memory Cell 310 of FIG. 3

| | WL/SG | | BL | | CG | | EG | | SL | |
|---|---|---|---|---|---|---|---|---|---|---|
| Read | 1.0-2 | V | 0.6-2 | V | 0-2.6 | V | 0-2.6 | V | 0 | V |
| Erase | −0.5 V/0 V | | 0 | V | 0 V/−8 V | | 8-12 | V | 0 | V |
| Program | 1 | V | 0.1-1 | μA | 8-11 | V | 4.5-9 | V | 4.5-5 | V |

FIG. 4 depicts a three-gate memory cell 410, which is another type of flash memory cell. Memory cell 410 is identical to the memory cell 310 of FIG. 3 except that memory cell 410 does not have a separate control gate. The erase operation (whereby erasing occurs through use of the erase gate) and read operation are similar to that of the FIG. 3 except there is no control gate bias applied. The programming operation also is done without the control gate bias, and as a result, a higher voltage is applied on the source line during a program operation to compensate for a lack of control gate bias.

Table No. 3 depicts typical voltage and current ranges that can be applied to the terminals of memory cell 410 for performing read, erase, and program operations:

TABLE NO 3
Operation of Flash Memory Cell 410 of FIG. 4

| | | | |
|---|---|---|---|
| WL/SG | BL | EG | SL |

| | | | | | | | | |
|---|---|---|---|---|---|---|---|---|
| Read | 0.7-2.2 | V | 0.6-2 | V | 0-2.6 | V | 0 | V |

| | | | | | | | |
|---|---|---|---|---|---|---|---|
| Erase | −0.5 V/0 V | 0 | V | 11.5 | V | 0 | V |

| | | | | | | | | |
|---|---|---|---|---|---|---|---|---|
| Program | 1 | V | 0.2-3 | μA | 4.5 | V | 7-9 | V |

FIG. 5 depicts stacked gate memory cell 510, which is another type of flash memory cell. Memory cell 510 is similar to memory cell 210 of FIG. 2, except that floating gate 20 extends over the entire channel region 18, and control gate 22 (which here will be coupled to a word line) extends over floating gate 20, separated by an insulating layer (not shown). The erase is done by FN tunneling of electrons from FG to substrate, programming is by channel hot electron (CHE) injection at region between the channel 18 and the drain region 16, by the electrons flowing from the source region 14 towards to drain region 16 and read operation which is similar to that for memory cell 210 with a higher control gate voltage.

Table No. 4 depicts typical voltage ranges that can be applied to the terminals of memory cell 510 and substrate 12 for performing read, erase, and program operations:

TABLE NO 4
Operation of Flash Memory Cell 510 of FIG. 5

| | CG | | BL | | SL | Substrate |
|---|---|---|---|---|---|---|
| Read | 2-5 | V | 0.6-2 | V | 0 V | 0 V |
| Erase | −8 to −10 V/0 V | | FLT | | FLT | 8-10 V/15-20 V |
| Program | 8-12 | V | 3-5 | V | 0 V | 0 V |

The methods and means described herein may apply to other non-volatile memory technologies such as FINFET split gate flash or stack gate flash memory, NAND flash, SONOS (silicon-oxide-nitride-oxide-silicon, charge trap in nitride), MONOS (metal-oxide-nitride-oxide-silicon, metal charge trap in nitride), ReRAM (resistive ram), PCM (phase change memory), MRAM (magnetic ram), FeRAM (ferroelectric ram), CT (charge trap) memory, CN (carbon-tube) memory, OTP (bi-level or multi-level one time programmable), and CeRAM (correlated electron ram), without limitation.

In order to utilize the memory arrays comprising one of the types of non-volatile memory cells described above in an artificial neural network, two modifications are made. First, the lines are configured so that each memory cell can be individually programmed, erased, and read without adversely affecting the memory state of other memory cells in the array, as further explained below. Second, continuous (analog) programming of the memory cells is provided.

Specifically, the memory state (i.e., charge on the floating gate) of each memory cell in the array can be continuously changed from a fully erased state to a fully programmed state, and vice-versa, independently and with minimal disturbance of other memory cells. This means the cell storage is effectively analog or at the very least can store one of many discrete values (such as 16 or 64 different values), which allows for very precise and individual tuning of all the memory cells in the memory array, and which makes the memory array ideal for storing and making fine tuning adjustments to the synapsis weights of the neural network.

### Neural Networks Employing Non-Volatile Memory Cell Arrays

FIG. 6 conceptually illustrates a non-limiting example of a neural network utilizing a non-volatile memory array of the present examples. This example uses the non-volatile memory array neural network for a facial recognition application, but any other appropriate application could be implemented using a non-volatile memory array based neural network.

S0 is the input layer, which for this example is a 32×32 pixel RGB image with 5 bit precision (i.e. three 32×32 pixel arrays, one for each color R, G and B, each pixel being 5 bit precision). The synapses CB1 going from input layer S0 to layer C1 apply different sets of weights in some instances and shared weights in other instances and scan the input image with 3×3 pixel overlapping filters (kernel), shifting the filter by 1 pixel (or more than 1 pixel as dictated by the model). Specifically, values for 9 pixels in a 3×3 portion of the image (i.e., referred to as a filter or kernel) are provided to the synapses CB1, where these 9 input values are multiplied by the appropriate weights and, after summing the outputs of that multiplication, a single output value is determined and provided by a first synapse of CB1 for generating a pixel of one of the feature maps of layer C1. The 3×3 filter is then shifted one pixel to the right within input layer S0 (i.e., adding the column of three pixels on the right, and dropping the column of three pixels on the left), whereby the 9 pixel values in this newly positioned filter are provided to the synapses CB1, where they are multiplied by the same weights and a second single output value is determined by the associated synapse. This process is continued until the 3×3 filter scans across the entire 32×32 pixel image of input layer S0, for all three colors and for all bits (precision values). The process is then repeated using different sets of weights to generate a different feature map of layer C1, until all the features maps of layer C1 have been calculated.

In layer C1, in the present example, there are 16 feature maps, with 30×30 pixels each. Each pixel is a new feature pixel extracted from multiplying the inputs and kernel, and therefore each feature map is a two dimensional array, and thus in this example layer C1 constitutes 16 layers of two dimensional arrays (keeping in mind that the layers and arrays referenced herein are logical relationships, not necessarily physical relationships—i.e., the arrays are not necessarily oriented in physical two dimensional arrays). Each of the 16 feature maps in layer C1 is generated by one of sixteen different sets of synapse weights applied to the filter scans. The C1 feature maps could all be directed to different aspects of the same image feature, such as boundary identification. For example, the first map (generated using a first weight set, shared for all scans used to generate this first map) could identify circular edges, the second map (generated using a second weight set different from the first weight set) could identify rectangular edges, or the aspect ratio of certain features, and so on.

An activation function P1 (pooling) is applied before going from layer C1 to layer S1, which pools values from consecutive, non-overlapping 2×2 regions in each feature map. The purpose of the pooling function P1 is to average out the nearby location (or a max function can also be used), to reduce the dependence of the edge location for example and to reduce the data size before going to the next stage. At layer S1, there are 16 15×15 feature maps (i.e., sixteen different arrays of 15×15 pixels each). The synapses CB2 going from layer S1 to layer C2 scan maps in layer S1 with 4×4 filters, with a filter shift of 1 pixel. At layer C2, there are 22 12×12 feature maps. An activation function P2 (pooling) is applied before going from layer C2 to layer S2, which pools values from consecutive non-overlapping 2×2 regions in each feature map. At layer S2, there are 22 6×6 feature maps. An activation function (pooling) is applied at the synapses CB3 going from layer S2 to layer C3, where every neuron in layer C3 connects to every map in layer S2 via a respective synapse of CB3. At layer C3, there are 64 neurons. The synapses CB4 going from layer C3 to the output layer S3 fully connects C3 to S3, i.e. every neuron in layer C3 is connected to every neuron in layer S3. The output at S3 includes 10 neurons, where the highest output neuron determines the class. This output could, for example, be indicative of an identification or classification of the contents of the original image.

Each layer of synapses is implemented using an array, or a portion of an array, of non-volatile memory cells.

FIG. 7 is a block diagram of an array that can be used for that purpose. Vector-by-matrix multiplication (VMM) array 32 includes non-volatile memory cells and is utilized as the synapses (such as CB1, CB2, CB3, and CB4 in FIG. 6) between one layer and the next layer. Specifically, VMM array 32 includes an array of non-volatile memory cells 33, erase gate and word line gate decoder 34, control gate decoder 35, bit line decoder 36 and source line decoder 37, which decode the respective inputs for the non-volatile memory cell array 33. Input to VMM array 32 can be from the erase gate and wordline gate decoder 34 or from the control gate decoder 35. Source line decoder 37 in this example also decodes the output of the non-volatile memory cell array 33. Alternatively, bit line decoder 36 can decode the output of the non-volatile memory cell array 33.

Non-volatile memory cell array 33 serves two purposes. First, it stores the weights that will be used by the VMM array 32. Second, the non-volatile memory cell array 33 effectively multiplies the inputs by the weights stored in the non-volatile memory cell array 33 and adds them up per output line (source line or bit line) to produce the output, which will be the input to the next layer or input to the final layer. By performing the multiplication and addition function, the non-volatile memory cell array 33 removes the need for separate multiplication and addition logic circuits and is also power efficient due to its in-situ memory computation.

The output of non-volatile memory cell array 33 is supplied to a differential summer (such as a summing op-amp or a summing current mirror) 38, which sums up the outputs of the non-volatile memory cell array 33 to create a single value for that convolution. The differential summer 38 is arranged to perform summation of positive weight and negative weight.

The summed-up output values of differential summer 38 are then supplied to an activation function block 39, which rectifies the output. The activation function block 39 may provide sigmoid, tanh, or ReLU functions. The rectified output values of activation function block 39 become an element of a feature map as the next layer (e.g. C1 in FIG. 6), and are then applied to the next synapse to produce the next feature map layer or final layer. Therefore, in this example, non-volatile memory cell array 33 constitutes a plurality of synapses (which receive their inputs from the prior layer of neurons or from an input layer such as an image database), and summing op-amp 38 and activation function block 39 constitute a plurality of neurons.

The input to VMM array 32 in FIG. 7 (WLx, EGx, CGx, and optionally BLx and SLx) can be analog level, binary level, or digital bits (in which case a DAC is provided to convert digital bits to appropriate input analog level) and the output can be analog level, binary level, or digital bits (in which case an output ADC is provided to convert output analog level into digital bits).

FIG. 8 is a block diagram depicting the usage of numerous layers of VMM arrays 32, here labeled as VMM arrays 32a, 32b, 32c, 32d, and 32e. As shown in FIG. 8, the input, denoted Inputx, is converted from digital to analog by a digital-to-analog converter 31 and provided to input VMM array 32a. The converted analog inputs could be voltage or current. The input D/A conversion for the first layer could be done by using a function or a LUT (look up table) that maps the inputs Inputx to appropriate analog levels for the matrix multiplier of input VMM array 32a. The input conversion could also be done by an analog to analog (A/A) converter to convert an external analog input to a mapped analog input to the input VMM array 32a.

The output generated by input VMM array 32a is provided as an input to the next VMM array (hidden level 1) 32b, which in turn generates an output that is provided as an input to the next VMM array (hidden level 2) 32c, and so on. The various layers of VMM array 32 function as different layers of synapses and neurons of a convolutional neural network (CNN). Each VMM array 32a, 32b, 32c, 32d, and 32e can be a stand-alone, physical non-volatile memory array, or multiple VMM arrays could utilize different portions of the same physical non-volatile memory array, or multiple VMM arrays could utilize overlapping portions of the same physical non-volatile memory array. The example shown in FIG. 8 contains five layers (32a, 32b, 32c, 32d, 32e): one input layer (32a), two hidden layers (32b, 32c), and two fully connected layers (32d, 32e). One of ordinary skill in the art will appreciate that this is merely an example and that a system instead could comprise more than two hidden layers and more than two fully connected layers.

### Vector-by-Matrix Multiplication (VMM) Arrays

FIG. 9 depicts neuron VMM array 900, which is particularly suited for memory cells 310 as shown in FIG. 3 and is utilized as the synapses and parts of neurons between an input layer and the next layer. VMM array 900 comprises memory array 901 of non-volatile memory cells and reference array 902 (at the top of the array) of non-volatile reference memory cells. Alternatively, another reference array can be placed at the bottom.

In VMM array 900, control gate lines, such as control gate line 903, run in a vertical direction (hence reference array 902 in the row direction is orthogonal to control gate line 903), and erase gate lines, such as erase gate line 904, run in a horizontal direction. Here, the inputs to VMM array 900 are provided on the control gate lines (CG0, CG1, CG2, CG3), and the output of VMM array 900 emerges on the source lines (SL0, SL1). In one example, only even rows are used, and in another example, only odd rows are used. The current placed on each source line (SL0, SL1, respectively) performs a summing function of all the currents from the memory cells connected to that particular source line.

As described herein for neural networks, the non-volatile memory cells of VMM array 900, i.e., the memory cells 310 of VMM array 900, may be configured to operate in a sub-threshold region.

The non-volatile reference memory cells and the non-volatile memory cells described herein are biased in weak inversion (sub threshold region):

$$Ids = Io * {e}^{( Vg - Vth ) / n V t} = w * Io * {e}^{( Vg ) / nVt} ,$$

$$where w = {e}^{( - Vth ) / n V t}$$

where Ids is the drain to source current; Vg is gate voltage on the memory cell; Vth is threshold voltage of the memory cell; Vt is thermal voltage=k*T/q with k being the Boltzmann constant, T the temperature in Kelvin, and q the electronic charge; n is a slope factor=1+(Cdep/Cox) with Cdep=capacitance of the depletion layer, and Cox capacitance of the gate oxide layer; Io is the memory cell current at gate voltage equal to threshold voltage, Io is proportional to (Wt/L)*u*Cox*(n−1)*Vt² where u is carrier mobility and Wt and L are width and length, respectively, of the memory cell.

For an I-to-V log converter using a memory cell (such as a reference memory cell or a peripheral memory cell) or a transistor to convert input current into an input voltage:

$$Vg = n * Vt * log [ Ids / wp * Io ]$$

where, wp is w of a reference or peripheral memory cell.

For a memory array used as a vector matrix multiplier VMM array with the current input, the output current is:

$$Iout = wa * Io * {e}^{( V g ) / n V t} , namely$$

$$Iout = ( wa / wp ) * Iin = W * Iin$$

$$W = {e}^{( Vthp - Vtha ) / nVt}$$

Here, wa=w of each memory cell in the memory array.
Vthp is effective threshold voltage of the peripheral memory cell and Vtha is effective threshold voltage of the main (data) memory cell. Note that the threshold voltage of a transistor is a function of substrate body bias voltage and the substrate body bias voltage, denoted Vsb, can be modulated to compensate for various conditions, on such temperature. The threshold voltage Vth can be expressed as:

$$Vth = Vth 0 + gamma ( SQRT \vert Vsb - 2 * φ F ) - SQRT \vert 2 * φ F \vert$$

where Vth0 is threshold voltage with zero substrate bias, φF is a surface potential, and gamma is a body effect parameter.

A wordline or control gate can be used as the input for the memory cell for the input voltage.

Alternatively, the flash memory cells of VMM arrays described herein can be configured to operate in the linear region:

$$Ids = beta * ( Vgs - V th ) * Vds ; beta = u * Cox * Wt / L$$

$$W = α ( Vgs - V th )$$

meaning weight W in the linear region is proportional to (Vgs-Vth)

A wordline or control gate or bitline or sourceline can be used as the input for the memory cell operated in the linear region. The bitline or sourceline can be used as the output for the memory cell.

For an I-to-V linear converter, a memory cell (such as a reference memory cell or a peripheral memory cell) or a transistor operating in the linear region can be used to linearly convert an input/output current into an input/output voltage.

Alternatively, the memory cells of VMM arrays described herein can be configured to operate in the saturation region:

$$Ids = 1 / 2 * beta * {( Vgs - Vth )}^{2} ; beta = u * Cox * Wt / L$$

$$W {α ( Vgs - Vth )}^{2} , meaning weight W is proportional to {( Vgs - Vth )}^{2}$$

A wordline, control gate, or erase gate can be used as the input for the memory cell operated in the saturation region. The bitline or sourceline can be used as the output for the output neuron.

Alternatively, the memory cells of VMM arrays described herein can be used in all regions or a combination thereof (sub threshold, linear, or saturation) for each layer or multi layers of a neural network.

Other examples for VMM array 32 of FIG. 7 are described in U.S. Pat. No. 10,748,630, which is incorporated by reference herein. As described in that application. a sourceline or a bitline can be used as the neuron output (current summation output).

FIG. 10 depicts neuron VMM array 1000, which is particularly suited for memory cells 210 as shown in FIG. 2 and is utilized as the synapses between an input layer and the next layer. VMM array 1000 comprises a memory array 1003 of non-volatile memory cells, reference array 1001 of first non-volatile reference memory cells, and reference array 1002 of second non-volatile reference memory cells. Reference arrays 1001 and 1002, arranged in the column direction of the array, serve to convert current inputs flowing into terminals BLR0, BLR1, BLR2, and BLR3 into voltage inputs WL0, WL1, WL2, and WL3. In effect, the first and second non-volatile reference memory cells are diode-connected through multiplexors 1014 (partially depicted) with current inputs flowing into them. The reference cells are tuned (e.g., programmed) to target reference levels. The target reference levels are provided by a reference mini-array matrix (not shown).

Memory array 1003 serves two purposes. First, it stores the weights that will be used by the VMM array 1000 on respective memory cells thereof. Second, memory array 1003 effectively multiplies the inputs (i.e. current inputs provided in terminals BLR0, BLR1, BLR2, and BLR3, which reference arrays 1001 and 1002 convert into the input voltages to supply to wordlines WL0, WL1, WL2, and WL3) by the weights stored in the memory array 1003 and then adds all the results (memory cell currents) to produce the output on the respective bit lines (BL0-BLN), which will be the input to the next layer or input to the final layer. By performing the multiplication and addition function, memory array 1003 negates the need for separate multiplication and addition logic circuits and is also power efficient. Here, the voltage inputs are provided on the word lines WL0, WL1, WL2, and WL3, and the output emerges on the respective bit lines BL0-BLN during a read (inference) operation. The current placed on each of the bit lines BL0-BLN performs a summing function of the currents from all non-volatile memory cells connected to that particular bitline.

Table No. 5 depicts operating voltages and currents for VMM array 1000. The columns in the table indicate the voltages placed on word lines for selected cells, word lines for unselected cells, bit lines for selected cells, bit lines for unselected cells, source lines for selected cells, and source lines for unselected cells. The rows indicate the operations of read, erase, and program.

TABLE NO. 5
Operation of VMM Array 1000 of FIG. 10:

| | WL | | WL -unsel | BL | | BL -unsel | SL | | SL -unsel | |
|---|---|---|---|---|---|---|---|---|---|---|
| Read | 1-3.5 | V | −0.5 V/0 V | 0.6-2 | V | 0.6 V-2 V/0 V | 0 | V | 0 | V |
| | | | | (Ineuron) | | | | | | |
| Erase | ~5-13 | V | 0 V | 0 | V | 0 V | 0 | V | 0 | V |
| Program | 1-2 | V | −0.5 V/0 V | 0.1-3 | uA | Vinh ~2.5 V | 4-10 | V | 0-1 | V/FLT |

FIG. 11 depicts neuron VMM array 1100, which is particularly suited for memory cells 210 as shown in FIG. 2 and is utilized as the synapses and parts of neurons between an input layer and the next layer. VMM array 1100 comprises a memory array 1103 of non-volatile memory cells, reference array 1101 of first non-volatile reference memory cells, and reference array 1102 of second non-volatile reference memory cells. Reference arrays 1101 and 1102 run in row direction of the VMM array 1100. VMM array is similar to VMM 1000 except that in VMM array 1100, the word lines run in the vertical direction. Here, the inputs are provided on the word lines (WLA0, WLB0, WLA1, WLB2, WLA2, WLB2, WLA3, WLB3), and the output emerges on the source line (SL0, SL1) during a read operation. The current placed on each source line performs a summing function of all the currents from the memory cells connected to that particular source line.

Table No. 6 depicts operating voltages and currents for VMM array 1100. The columns in the table indicate the voltages placed on word lines for selected cells, word lines for unselected cells, bit lines for selected cells, bit lines for unselected cells, source lines for selected cells, and source lines for unselected cells. The rows indicate the operations of read, erase, and program.

TABLE NO. 6
Operation of VMM Array 1100 of FIG. 11

| | WL | | WL -unsel | BL | | BL -unsel | SL | | SL -unsel | |
|---|---|---|---|---|---|---|---|---|---|---|
| Read | 1-3.5 | V | −0.5 V/0 V | 0.6-2 | V | 0.6 V-2 V/0 V | ~0.3-1 | V | 0 | V |
| | | | | | | | (Ineuron) | | | |
| Erase | ~5-13 | V | 0 V | 0 | V | 0 V | 0 | V | SL-inhibit | |
| | | | | | | | | | (~4-8 | V) |
| Program | 1-2 | V | −0.5 V/0 V | 0.1-3 | uA | Vinh ~2.5 V | 4-10 | V | 0-1 | V/FLT |

FIG. 12 depicts neuron VMM array 1200, which is particularly suited for memory cells 310 as shown in FIG. 3 and is utilized as the synapses and parts of neurons between an input layer and the next layer. VMM array 1200 comprises a memory array 1203 of non-volatile memory cells, reference array 1201 of first non-volatile reference memory cells, and reference array 1202 of second non-volatile reference memory cells. Reference arrays 1201 and 1202 serve to convert current inputs flowing into terminals BLR0, BLR1, BLR2, and BLR3 into voltage inputs CG0, CG1, CG2, and CG3. In effect, the first and second non-volatile reference memory cells are diode-connected through multiplexors 1212 (partially shown) with current inputs flowing into them through BLR0, BLR1, BLR2, and BLR3. Multiplexors 1212 each include a respective multiplexor 1205 and a cascoding transistor 1204 to ensure a constant voltage on the bitline (such as BLR0) of each of the first and second non-volatile reference memory cells during a read operation. The reference cells are tuned to target reference levels.

Memory array 1203 serves two purposes. First, it stores the weights that will be used by the VMM array 1200. Second, memory array 1203 effectively multiplies the inputs (current inputs provided to terminals BLR0, BLR1, BLR2, and BLR3, for which reference arrays 1201 and 1202 convert these current inputs into the input voltages to supply to the control gates (CG0, CG1, CG2, and CG3) by the weights stored in the memory array and then add all the results (cell currents) to produce the output, which appears on BL0-BLN, and will be the input to the next layer or input to the final layer. By performing the multiplication and addition function, the memory array negates the need for separate multiplication and addition logic circuits and is also power efficient. Here, the inputs are provided on the control gate lines (CG0, CG1, CG2, and CG3), and the output emerges on the bit lines (BL0-BLN) during a read operation. The current placed on each bitline performs a summing function of all the currents from the memory cells connected to that particular bitline.

VMM array 1200 implements uni-directional tuning for non-volatile memory cells in memory array 1203. That is, each non-volatile memory cell is erased and then partially programmed until the desired charge on the floating gate is reached. If too much charge is placed on the floating gate (such that the wrong value is stored in the cell), the cell is erased and the sequence of partial programming operations starts over. As shown, two rows sharing the same erase gate (such as EG0 or EG1) are erased together (which is known as a page erase), and thereafter, each cell is partially programmed until the desired charge on the floating gate is reached.

Table No. 7 depicts operating voltages and currents for VMM array 1200. The columns in the table indicate the voltages placed on word lines for selected cells, word lines for unselected cells, bit lines for selected cells, bit lines for unselected cells, control gates for selected cells, control gates for unselected cells in the same sector as the selected cells, control gates for unselected cells in a different sector than the selected cells, erase gates for selected cells, erase gates for unselected cells, source lines for selected cells, and source lines for unselected cells. The rows indicate the operations of read, erase, and program.

TABLE NO. 7
Operation of VMM Array 1200 of FIG. 12

| | | | | | | | | | | CG - | | | | | | | | |
|---|---|---|---|---|---|---|---|---|---|---|---|---|---|---|---|---|---|---|
| | | | | | | | | | | unsel | | | | | | | | |
| | | | WL - | | | BL - | | | | same | CG - | | | EG - | | | SL - | |
| | WL | | unsel | BL | | unsel | | CG | | sector | unsel | EG | | unsel | SL | | unsel | |
| Read | 1.0-2 | V | −0.5 V/ 0 V | 0.6-2 | V | 0 | V | 0-2.6 | V | 0-2.6 V | 0-2.6 V | 0-2.6 | V | 0-2.6 V | 0 | V | 0 | V |
| | | | | (Ineuron) | | | | | | | | | | | | | | |
| Erase | 0 | V | 0 V | 0 | V | 0 | V | 0 | V | 0-2.6 V | 0-2.6 V | 5-12 | V | 0-2.6 V | 0 | V | 0 | V |

| | | | | | | | | | | | | | | | | | |
|---|---|---|---|---|---|---|---|---|---|---|---|---|---|---|---|---|---|
| Program | 0.7-1 | V | −0.5 V/0 V | 0.1-1 | uA | Vinh | 4-11 | V | 0-2.6 V | 0-2.6 V | 4.5-5 | V | 0-2.6 V | 4.5-5 | V | 0-1 | V |

| | |
|---|---|
| (1-2 | V) |

FIG. 13 depicts neuron VMM array 1300, which is particularly suited for memory cells 310 as shown in FIG. 3, and is utilized as the synapses and parts of neurons between an input layer and the next layer. VMM array 1300 comprises a memory array 1303 of non-volatile memory cells, reference array 1301 or first non-volatile reference memory cells, and reference array 1302 of second non-volatile reference memory cells. EG lines EGR0, EG0, EG1 and EGR1 are run vertically while CG lines CG0, CG1, CG2 and CG3 and SL lines WL0, WL1, WL2 and WL3 are run horizontally. VMM array 1300 is similar to VMM array 1400, except that VMM array 1300 implements bi-directional tuning, where each individual cell can be completely erased, partially programmed, and partially erased as needed to reach the desired amount of charge on the floating gate due to the use of separate EG lines. As shown, reference arrays 1301 and 1302 convert input current in the terminal BLR0, BLR1, BLR2, and BLR3 into control gate voltages CG0, CG1, CG2, and CG3 (through the action of diode-connected reference cells through multiplexors 1314) to be applied to the memory cells in the row direction. The current output (neuron) is in the bit lines BL0-BLN, where each bit line sums all currents from the non-volatile memory cells connected to that particular bitline.

Table No. 8 depicts operating voltages and currents for VMM array 1300. The columns in the table indicate the voltages placed on word lines for selected cells, word lines for unselected cells, bit lines for selected cells, bit lines for unselected cells, control gates for selected cells, control gates for unselected cells in the same sector as the selected cells, control gates for unselected cells in a different sector than the selected cells, erase gates for selected cells, erase gates for unselected cells, source lines for selected cells, and source lines for unselected cells. The rows indicate the operations of read, erase, and program.

TABLE NO. 8
Operation of VMM Array 1300 of FIG. 13

| | | | | | | | | | | CG -unsel | | | | | | | | | |
|---|---|---|---|---|---|---|---|---|---|---|---|---|---|---|---|---|---|---|---|
| | | | WL - | | | BL - | | | | same | | CG - | | | EG - | | | SL - | |
| | WL | | unsel | BL | | unsel | | CG | | sector | | unsel | EG | | unsel | SL | | unsel | |
| Read | 1.0-2 | V | −0.5 V/0 V | 0.6-2 | V | 0 | V | 0-2.6 | V | 0-2.6 | V | 0-2.6 V | 0-2.6 | V | 0-2.6 V | 0 | V | 0 | V |
| | | | | (Ineuron) | | | | | | | | | | | | | | | |
| Erase | 0 | V | 0 V | 0 | V | 0 | V | 0 | V | 4-9 | V | 0-2.6 V | 5-12 | V | 0-2.6 V | 0 | V | 0 | V |

| | | | | | | | | | | | | | | | | | | |
|---|---|---|---|---|---|---|---|---|---|---|---|---|---|---|---|---|---|---|
| Program | 0.7-1 | V | −0.5 V/0 V | 0.1-1 | uA | Vinh | 4-11 | V | 0-2.6 | V | 0-2.6 V | 4.5-5 | V | 0-2.6 V | 4.5-5 | V | 0-1 | V |

| | |
|---|---|
| (1-2 | V) |

FIG. 22 depicts neuron VMM array 2200, which is particularly suited for memory cells 210 as shown in FIG. 2 and is utilized as the synapses and parts of neurons between an input layer and the next layer. In VMM array 2200, the inputs INPUT₀ . . . . , INPUT_{N} are received on bit lines BL₀, . . . BL_{N}, respectively, and the outputs OUTPUT₁, OUTPUT₂, OUTPUT₃, and OUTPUT₄ are generated on source lines SL₀, SL₁, SL₂, and SL₃, respectively.

FIG. 23 depicts neuron VMM array 2300, which is particularly suited for memory cells 210 as shown in FIG. 2 and is utilized as the synapses and parts of neurons between an input layer and the next layer. In this example, the inputs INPUT₀, INPUT₁, INPUT₂, and INPUT₃ are received on source lines SL₀, SL₁, SL₂, and SL₃, respectively, and the outputs OUTPUT₀, . . . OUTPUT_{N} are generated on bit lines BL₀, . . . , BLN.

FIG. 24 depicts neuron VMM array 2400, which is particularly suited for memory cells 210 as shown in FIG. 2, and is utilized as the synapses and parts of neurons between an input layer and the next layer. In this example, the inputs INPUT₀, . . . , INPUT_{M} are received on word lines WL₀, . . . , WL_{M}, respectively, and the outputs OUTPUT₀, . . . OUTPUT_{N} are generated on bit lines BL₀, . . . , BLN.

FIG. 25 depicts neuron VMM array 2500, which is particularly suited for memory cells 310 as shown in FIG. 3, and is utilized as the synapses and parts of neurons between an input layer and the next layer. In this example, the inputs INPUT₀, . . . , INPUT_{M} are received on word lines WL₀, . . . , WL_{M}, respectively, and the outputs OUTPUT₀, . . . OUTPUT_{N} are generated on bit lines BL₀, . . . , BL_{N}.

FIG. 26 depicts neuron VMM array 2600, which is particularly suited for memory cells 410 as shown in FIG. 4, and is utilized as the synapses and parts of neurons between an input layer and the next layer. In this example, the inputs INPUT₀, . . . , INPUTₙ are received on vertical control gate lines CG₀, . . . , CG_{N}r, respectively, and the outputs OUTPUT₁ and OUTPUT₂ are generated on source lines SL₀ and SL₁.

FIG. 27 depicts neuron VMM array 2700, which is particularly suited for memory cells 410 as shown in FIG. 4 and is utilized as the synapses and parts of neurons between an input layer and the next layer. In this example, the inputs INPUT₀, . . . , INPUT_{N} are received on the gates of bit line control gates 2701-1, 2701-2, . . . , 2701-(N−1), and 2701-N, respectively, which are coupled to bit lines BL₀, . . . , BL_{N}, respectively. Example outputs OUTPUT₁ and OUTPUT₂ are generated on source lines SL₀ and SL₁.

FIG. 28 depicts neuron VMM array 2800, which is particularly suited for memory cells 310 as shown in FIG. 3, memory cells 510 as shown in FIG. 5, and memory cells 710 as shown in FIG. 7, and is utilized as the synapses and parts of neurons between an input layer and the next layer. In this example, the inputs INPUT₀, . . . , INPUT_{M} are received on word lines WL₀, . . . , WL_{M}, and the outputs OUTPUT₀, . . . , OUTPUT_{N} are generated on bit lines BL₀, . . . BL_{N}, respectively.

FIG. 29 depicts neuron VMM array 2900, which is particularly suited for memory cells 310 as shown in FIG. 3, memory cells 510 as shown in FIG. 5, and memory cells 710 as shown in FIG. 7, and is utilized as the synapses and parts of neurons between an input layer and the next layer. In this example, the inputs INPUT₀, . . . , INPUT_{M} are received on control gate lines CG₀, . . . , CG_{M}. Outputs OUTPUT₀, . . . , OUTPUT_{N} are generated on vertical source lines SL₀, . . . , SL_{N}, respectively, where each source line SLᵢ is coupled to the source lines of all memory cells in column i.

FIG. 30 depicts neuron VMM array 3000, which is particularly suited for memory cells 310 as shown in FIG. 3, memory cells 510 as shown in FIG. 5, and memory cells 710 as shown in FIG. 7, and is utilized as the synapses and parts of neurons between an input layer and the next layer. In this example, the inputs INPUT₀, . . . , INPUT_{M} are received on control gate lines CG₀, . . . , CG_{M}. Outputs OUTPUT₀, . . . , OUTPUT_{N} are generated on vertical bit lines BL₀, . . . , BL_{N}, respectively, where each bit line BLᵢ is coupled to the bit lines of all memory cells in column i.

### Long Short-Term Memory

The prior art includes a concept known as long short-term memory (LSTM). LSTM units often are used in neural networks. LSTM allows a neural network to remember information over predetermined arbitrary time intervals and to use that information in subsequent operations. A conventional LSTM unit comprises a cell, an input gate, an output gate, and a forget gate. The three gates regulate the flow of information into and out of the cell and the time interval that the information is remembered in the LSTM. VMMs are particularly useful in LSTM units.

FIG. 14 depicts an example LSTM 1400. LSTM 1400 in this example comprises cells 1401, 1402, 1403, and 1404. Cell 1401 receives input vector x₀ and generates output vector h₀ and cell state vector c₀. Cell 1402 receives input vector x₁, the output vector (hidden state) h₀ from cell 1401, and cell state c₀ from cell 1401 and generates output vector h₁ and cell state vector c₁. Cell 1403 receives input vector x₂, the output vector (hidden state) h₁ from cell 1402, and cell state c₁ from cell 1402 and generates output vector h₂ and cell state vector c₂. Cell 1404 receives input vector x₃, the output vector (hidden state) h₂ from cell 1403, and cell state c₂ from cell 1403 and generates output vector h₃. Additional cells can be used, and an LSTM with four cells is merely an example.

FIG. 15 depicts an example implementation of an LSTM cell 1500, which can be used for cells 1401, 1402, 1403, and 1404 in FIG. 14. LSTM cell 1500 receives input vector x(t), cell state vector c(t−1) from a preceding cell, and output vector h(t−1) from a preceding cell, and generates cell state vector c(t) and output vector h(t).

LSTM cell 1500 comprises sigmoid function devices 1501, 1502, and 1503, each of which applies a number between 0 and 1 to control how much of each component in the input vector is allowed through to the output vector. LSTM cell 1500 also comprises tanh devices 1504 and 1505 to apply a hyperbolic tangent function to an input vector, multiplier devices 1506, 1507, and 1508 to multiply two vectors together, and addition device 1509 to add two vectors together. Output vector h(t) can be provided to the next LSTM cell in the system, or it can be accessed for other purposes.

FIG. 16 depicts an LSTM cell 1600, which is an example of an implementation of LSTM cell 1500. For the reader's convenience, the same numbering from LSTM cell 1500 is used in LSTM cell 1600. Sigmoid function devices 1501, 1502, and 1503 and tanh device 1504 each comprise multiple VM-M arrays 1601 and activation function blocks 1602. Thus, it can be seen that VMM arrays are particular useful in LSTM cells used in certain neural network systems. The multiplier devices 1506, 1507, and 1508 and the addition device 1509 are implemented in a digital manner or in an analog manner. The activation function blocks 1602 can be implemented in a digital manner or in an analog manner.

An alternative to LSTM cell 1600 (and another example of an implementation of LSTM cell 1500) is shown in FIG. 17. In FIG. 17, sigmoid function devices 1501, 1502, and 1503 and tanh device 1504 share the same physical hardware (VMM arrays 1701 and activation function block 1702) in a time-multiplexed fashion. LSTM cell 1700 also comprises multiplier device 1703 to multiply two vectors together, addition device 1708 to add two vectors together, tanh device 1505 (which comprises activation function block 1702), register 1707 to store the value i(t) when i(t) is output from sigmoid function block 1702, register 1704 to store the value f(t)*c(t−1) when that value is output from multiplier device 1703 through multiplexor 1710, register 1705 to store the value i(t)*u(t) when that value is output from multiplier device 1703 through multiplexor 1710, and register 1706 to store the value o(t)*c˜(t) when that value is output from multiplier device 1703 through multiplexor 1710, and multiplexor 1709.

Whereas LSTM cell 1600 contains multiple sets of VMM arrays 1601 and respective activation function blocks 1602, LSTM cell 1700 contains one set of VMM/arrays 1701 and activation function block 1702, which are used to represent multiple layers in the example of LSTM cell 1700. LSTM cell 1700 will require less space than LSTM 1600, as LSTM cell 1700 will require ¼ as much space for VMMs and activation function blocks compared to LSTM cell 1600.

It can be further appreciated that LSTM units will typically comprise multiple VMM arrays, each of which uses functionality provided by certain circuit blocks outside of the VMM arrays, such as a summer and activation function block and high voltage generation blocks. Providing separate circuit blocks for each VMM array would require a significant amount of space within the semiconductor device and would be somewhat inefficient. The examples described below therefore reduce the circuitry used outside of the VMM arrays themselves.

### Gated Recurrent Units

An analog VMM implementation can be utilized for a GRU (gated recurrent unit) system. GRUs are a gating mechanism in recurrent neural networks. GRUs are similar to LSTMs, except that GRU cells generally contain fewer components than an LSTM cell.

FIG. 18 depicts an example GRU 1800. GRU 1800 in this example comprises cells 1801, 1802, 1803, and 1804. Cell 1801 receives input vector x₀ and generates output vector h₀. Cell 1802 receives input vector x₁, the output vector h₀ from cell 1801 and generates output vector h₁. Cell 1803 receives input vector x₂ and the output vector (hidden state) h₁ from cell 1802 and generates output vector h₂. Cell 1804 receives input vector x₃ and the output vector (hidden state) h₂ from cell 1803 and generates output vector h; Additional cells can be used, and an GRU with four cells is merely an example.

FIG. 19 depicts an example implementation of a GRU cell 1900, which can be used for cells 1801, 1802, 1803, and 1804 of FIG. 18. GRU cell 1900 receives input vector x(t) and output vector h(t−1) from a preceding GRU cell and generates output vector h(t). GRU cell 1900 comprises sigmoid function devices 1901 and 1902, each of which applies a number between 0 and 1 to components from output vector h(t−1) and input vector x(t). GRU cell 1900 also comprises a tanh device 1903 to apply a hyperbolic tangent function to an input vector, a plurality of multiplier devices 1904, 1905, and 1906 to multiply two vectors together, an addition device 1907 to add two vectors together, and a complementary device 1908 to subtract an input from 1 to generate an output.

FIG. 20 depicts a GRU cell 2000, which is an example of an implementation of GRU cell 1900. For the reader's convenience, the same numbering from GRU cell 1900 is used in GRU cell 2000. As can be seen in FIG. 20, sigmoid function devices 1901 and 1902, and tanh device 1903 each comprise multiple VMM arrays 2001 and activation function blocks 2002. Thus, it can be seen that VMM arrays are of particular use in GRU cells used in certain neural network systems. The multiplier devices 1904, 1905, 1906, the addition device 1907, and the complementary device 1908 are implemented in a digital manner or in an analog manner. The activation function blocks 2002 can be implemented in a digital manner or in an analog manner.

An alternative to GRU cell 2000 (and another example of an implementation of GRU cell 1900) is shown in FIG. 21. In FIG. 21, GRU cell 2100 utilizes VMM arrays 2101 and activation function block 2102, which when configured as a sigmoid function applies a number between 0 and 1 to control how much of each component in the input vector is allowed through to the output vector. In FIG. 21, sigmoid function devices 1901 and 1902 and tanh device 1903 share the same physical hardware (VMM arrays 2101 and activation function block 2102) in a time-multiplexed fashion. GRU cell 2100 also comprises multiplier device 2103 to multiply two vectors together, addition device 2105 to add two vectors together, complementary device 2109 to subtract an input from 1 to generate an output, multiplexor 2104, register 2106 to hold the value h(t−1)*r(t) when that value is output from multiplier device 2103 through multiplexor 2104, register 2107 to hold the value h(t−1)*z(t) when that value is output from multiplier device 2103 through multiplexor 2104, and register 2108 to hold the value h\hat{ }(t)*(1−z(t)) when that value is output from multiplier device 2103 through multiplexor 2104.

Whereas GRU cell 2000 contains multiple sets of VMM arrays 2001 and activation function blocks 2002, GRU cell 2100 contains one set of VMM arrays 2101 and activation function block 2102, which are used to represent multiple layers in the example of GRU cell 2100. CRU cell 2100 will require less space than GRU cell 2000, as GRU cell 2100 will require ⅓ as much space for VMMs and activation function blocks compared to GRU cell 2000.

It can be further appreciated that GRU systems will typically comprise multiple VMM arrays, each of which uses functionality provided by certain circuit blocks outside of the VMM arrays, such as a summer and activation function block and high voltage generation blocks. Providing separate circuit blocks for each VMM array would require a significant amount of space within the semiconductor device and would be somewhat inefficient. The examples described below therefore reduce the circuitry used outside of the VMM arrays themselves.

The input to the VMM arrays can be an analog level, a binary level, a pulse, a time modulated pulse, or digital bits (in this case a DAC is used to convert digital bits to appropriate input analog level) and the output can be an analog level, a binary level, a timing pulse, pulses, or digital bits (in this case an output ADC is used to convert output analog level into digital bits).

In general, for each memory cell in a VMM array, each weight W can be implemented by a single memory cell or by a differential cell or by two blend memory cells (average of 2 cells). In the differential cell case, two memory cells are used to implement a weight W as a differential weight (W=W+−W−). In the two blend memory cells, two memory cells are used to implement a weight W as an average of two cells.

FIG. 31 depicts VMM system 3100. In some examples, the weights, W, stored in a VMM array are stored as differential pairs, W+(positive weight) and W− (negative weight), where W=(W+)−(W−). In VMM system 3100, half of the bit lines are designated as W+ lines, that is, bit lines connecting to memory cells that will store positive weights W+, and the other half of the bit lines are designated as W− lines, that is, bit lines connecting to memory cells implementing negative weights W−. The W− lines are interspersed among the W+ lines in an alternating fashion. The subtraction operation is performed by a summation circuit that receives current from a W+ line and a W− line, such as summation circuits 3101 and 3102. The output of a W+ line and the output of a W− line are combined together to give effectively W=W+−W− for each pair of (W+, W−) cells for all pairs of (W+, W−) lines. While the above has been described in relation to W− lines interspersed among the W+ lines in an alternating fashion, in other examples W+ lines and W− lines can be arbitrarily located anywhere in the array.

FIG. 32 depicts another example. In VMM system 3210, positive weights W+ are implemented in first array 3211 and negative weights W− are implemented in a second array 3212, second array 3212 separate from the first array, and the resulting weights are appropriately combined together by summation circuits 3213.

FIG. 33 depicts VMM system 3300. the weights, W, stored in a VMM array are stored as differential pairs, W+(positive weight) and W− (negative weight), where W=(W+)−(W−). VMM system 3300 comprises array 3301 and array 3302. Half of the bit lines in each of array 3301 and 3302 are designated as W+ lines, that is, bit lines connecting to memory cells that will store positive weights W+, and the other half of the bit lines in each of array 3301 and 3302 are designated as W− lines, that is, bit lines connecting to memory cells implementing negative weights W−. The W− lines are interspersed among the W+ lines in an alternating fashion. The subtraction operation is performed by a summation circuit that receives current from a W+ line and a W− line, such as summation circuits 3303, 3304, 3305, and 3306. The output of a W+ line and the output of a W− line from each array 3301, 3302 are respectively combined together to give effectively W=W+−W− for each pair of (W+, W−) cells for all pairs of (W+, W−) lines. In addition, the W values from each array 3301 and 3302 can be further combined through summation circuits 3307 and 3308, such that each W value is the result of a W value from array 3301 minus a W value from array 3302, meaning that the end result from summation circuits 3307 and 3308 is a differential value of two differential values.

Each non-volatile memory cells used in the analog neural memory system is to be erased and programmed to hold a very specific and precise amount of charge, i.e., the number of electrons, in the floating gate. For example, each floating gate can hold one of N different values, where N is the number of different weights that can be indicated by each cell. Examples of N include 16, 32, 64, 128, and 256.

Prior art systems require significant area and involve significant latency at the output stage. For example, multiple clock cycles are used to convert analog current received from the VMM array into digital output data.

It is desirable to reduce latency at the output to increase the overall speed of operation of the system, which system represents some or all of an artificial neural network.

### SUMMARY OF THE INVENTION

Numerous examples are disclosed of an output circuit and associated methods for a neural network array.

### BRIEF DESCRIPTION OF THE DRAWINGS

FIG. 1 is a diagram that illustrates an artificial neural network.

FIG. 2 depicts a prior art split gate flash memory cell.

FIG. 3 depicts another prior art split gate flash memory cell.

FIG. 4 depicts another prior art split gate flash memory cell.

FIG. 5 depicts another prior art split gate flash memory cell.

FIG. 6 is a diagram illustrating the different levels of an artificial neural network utilizing one or more non-volatile memory arrays.

FIG. 7 is a block diagram illustrating a VMM system.

FIG. 8 is a block diagram illustrates an example artificial neural network utilizing one or more VMM systems.

FIG. 9 depicts another example of a VMM system.

FIG. 10 depicts another example of a VMM system.

FIG. 11 depicts another example of a VMM system.

FIG. 12 depicts another example of a VMM system.

FIG. 13 depicts another example of a VMM system.

FIG. 14 depicts a prior art long short-term memory system.

FIG. 15 depicts an example cell for use in a long short-term memory system.

FIG. 16 depicts an example implementation of the cell of FIG. 15.

FIG. 17 depicts another example implementation of the cell of FIG. 15.

FIG. 18 depicts a prior art gated recurrent unit system.

FIG. 19 depicts an example cell for use in a gated recurrent unit system.

FIG. 20 depicts an example implementation t of the cell of FIG. 19.

FIG. 21 depicts another example implementation of the cell of FIG. 19.

FIG. 22 depicts another example of a VMM system.

FIG. 23 depicts another example of a VMM system.

FIG. 24 depicts another example of a VMM system.

FIG. 25 depicts another example of a VMM system.

FIG. 26 depicts another example of a VMM system.

FIG. 27 depicts another example of a VMM system.

FIG. 28 depicts another example of a VMM system.

FIG. 29 depicts another example of a VMM system.

FIG. 30 depicts another example of a VMM system.

FIG. 31 depicts another example of a VMM system.

FIG. 32 depicts another example of a VMM system.

FIG. 33 depicts another example of a VMM system.

FIG. 34 depicts another example of a VMM system.

FIG. 35 depicts an output circuit for a VMM system.

FIG. 36A depicts a clock generator.

FIG. 36B depicts a clock generator.

FIG. 37 depicts an output circuit for a VMM system.

FIG. 38A depicts an output circuit for a VMM system.

FIG. 38B depicts another output circuit for a VMM system.

FIG. 38C depicts another output circuit for a VMM system.

FIG. 38D depicts another output circuit for a VMM system.

FIG. 38E depicts another output circuit for a VMM system.

FIG. 39A depicts a timing diagram for an output circuit.

FIG. 39B depicts a timing diagram for another output circuit.

FIG. 39C depicts a timing diagram for another output circuit.

FIG. 39D depicts a timing diagram for another output circuit.

FIG. 40 depicts an output circuit for a VMM system.

FIG. 41 depicts a reference voltage generator.

FIG. 42 depicts a successive approximation register analog-to-digital converter.

FIG. 43 depicts a voltage generator.

FIG. 44 depicts a voltage generator.

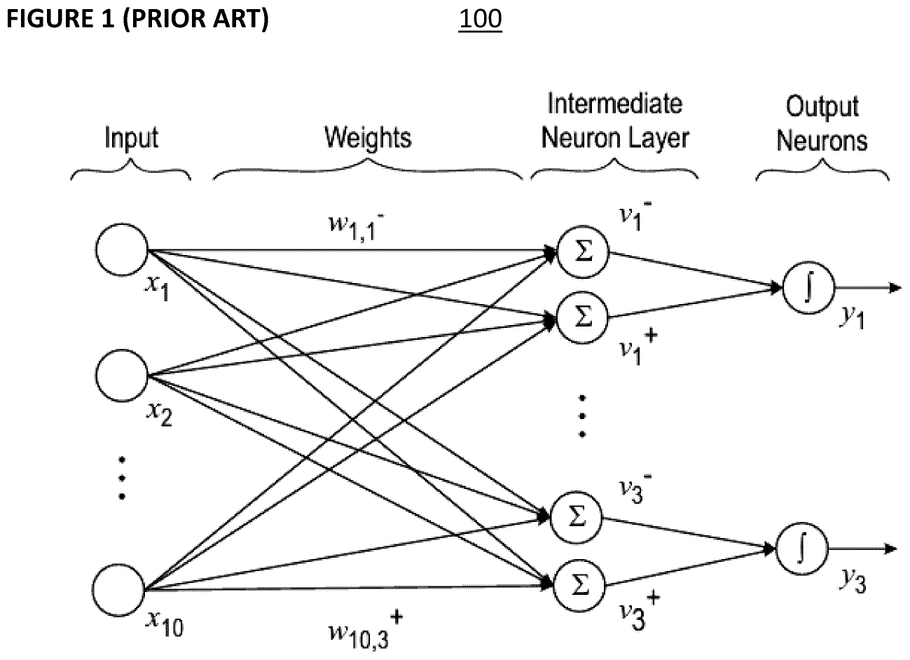

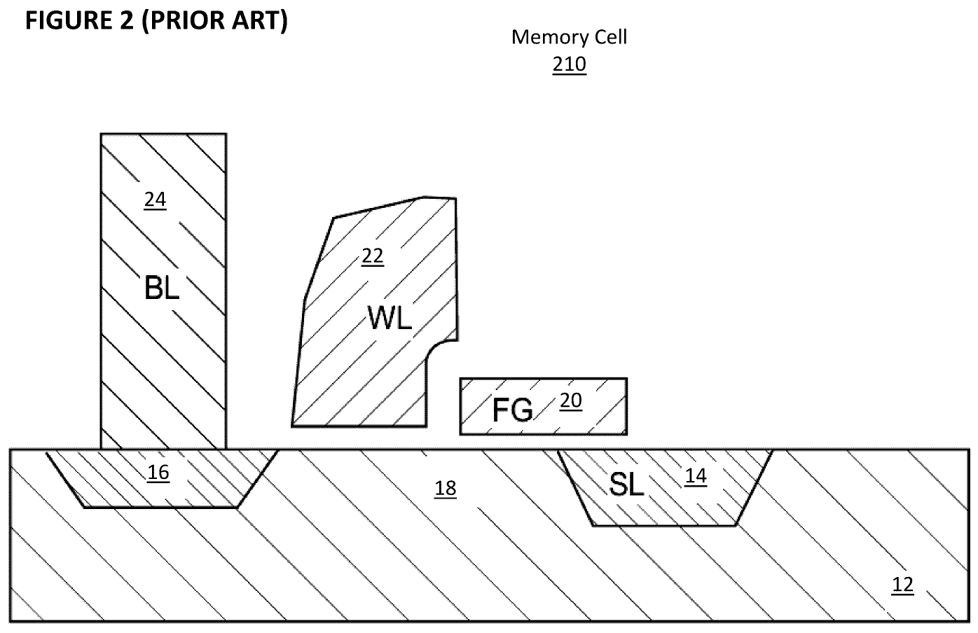

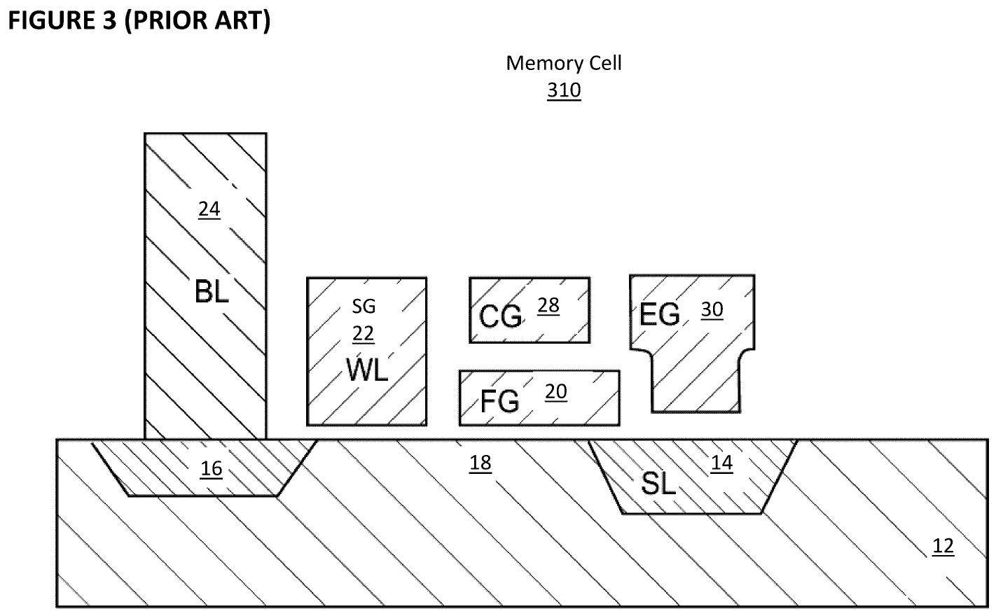

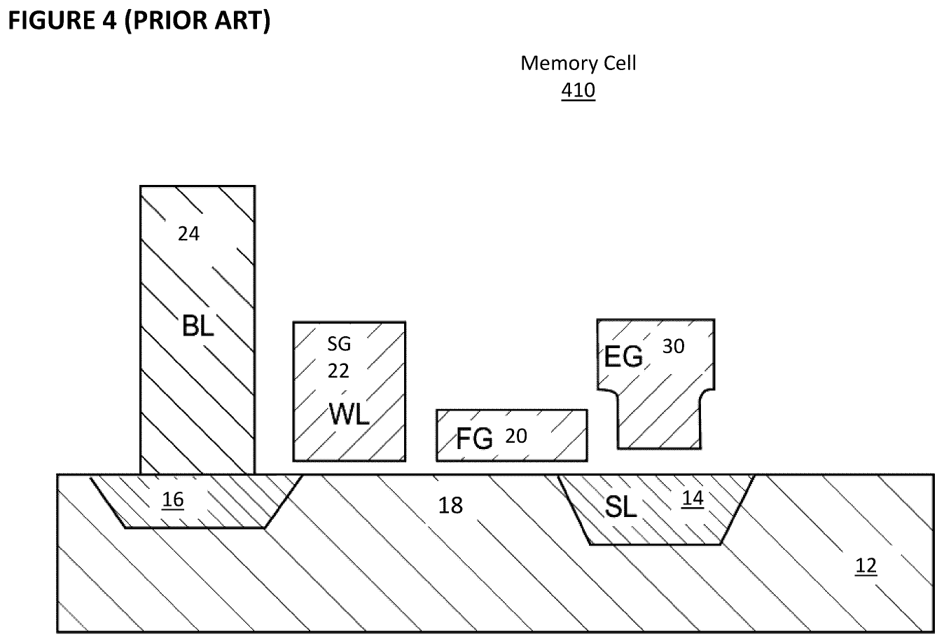

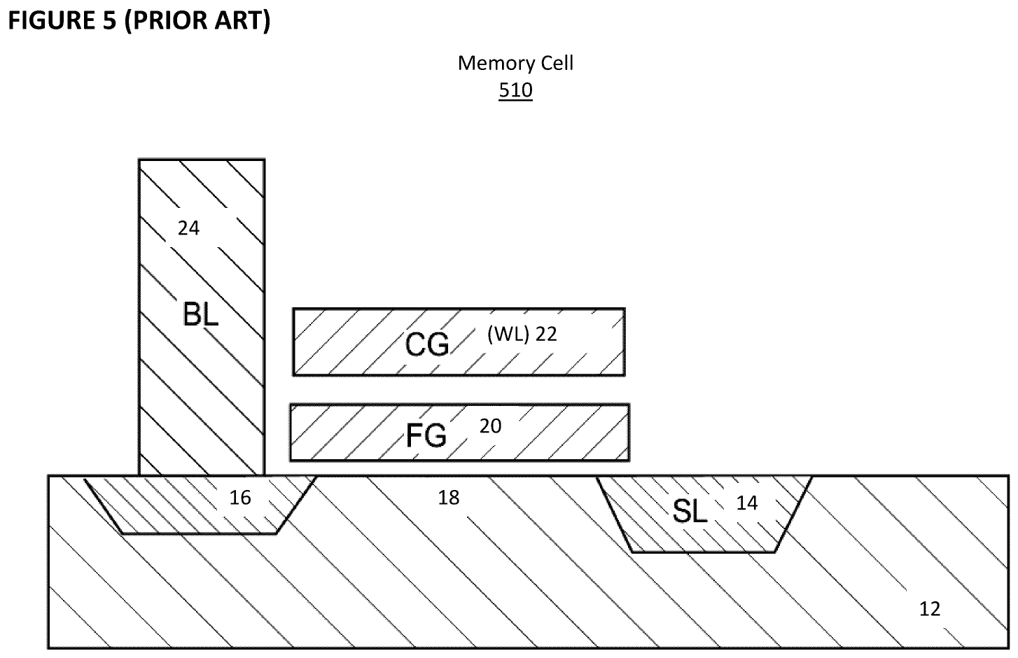

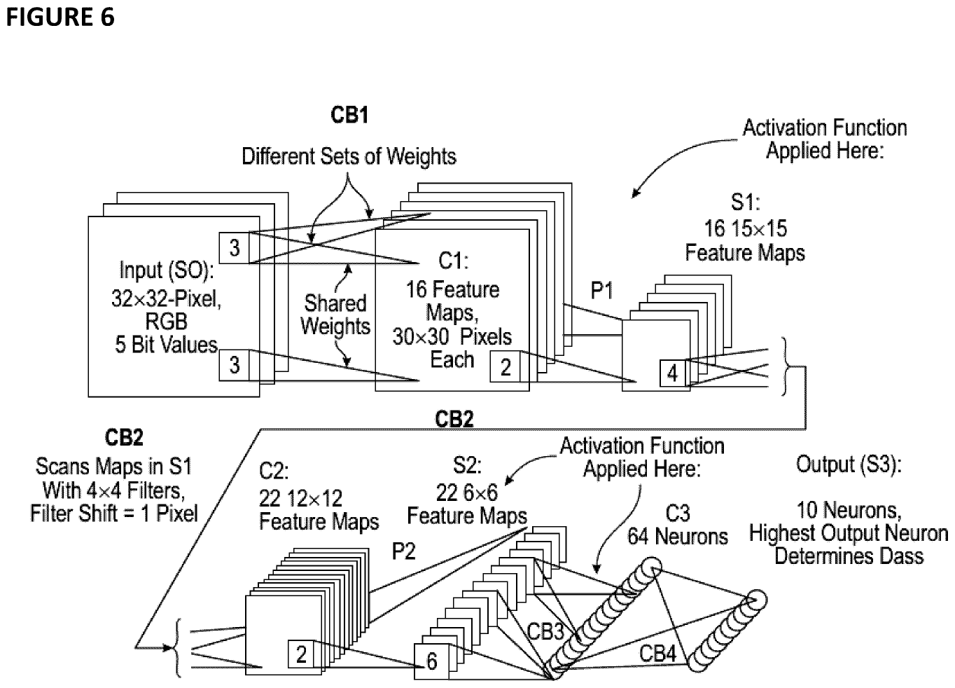

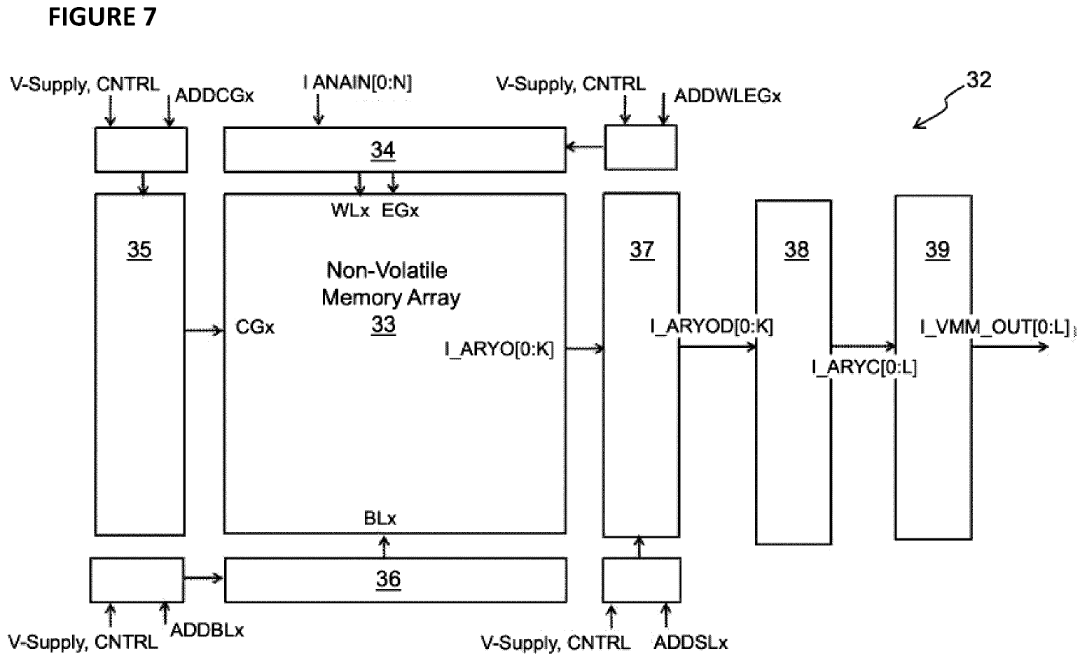

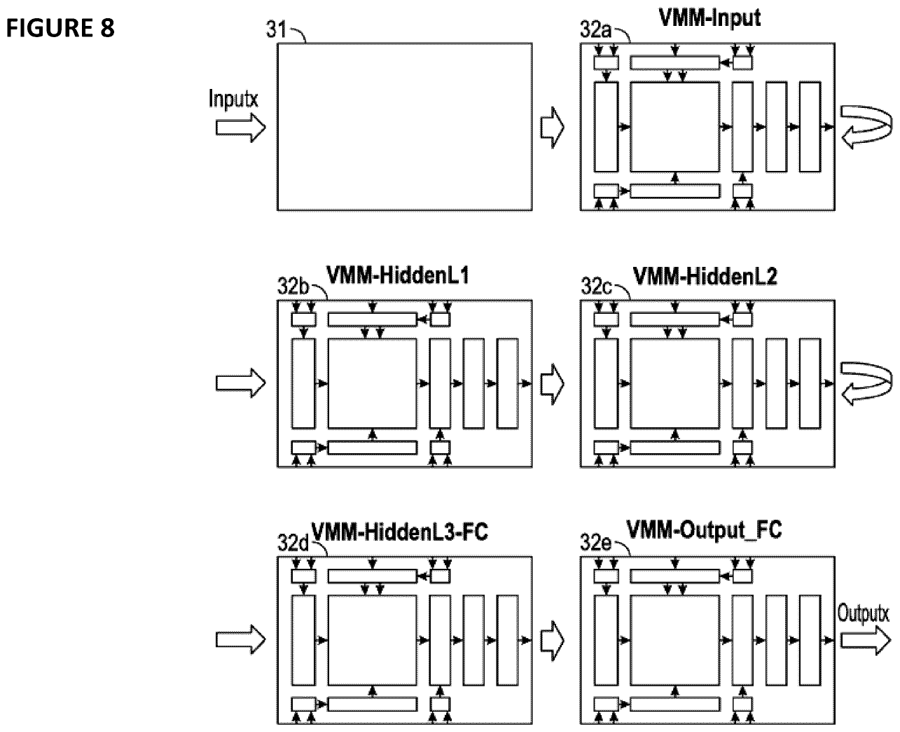

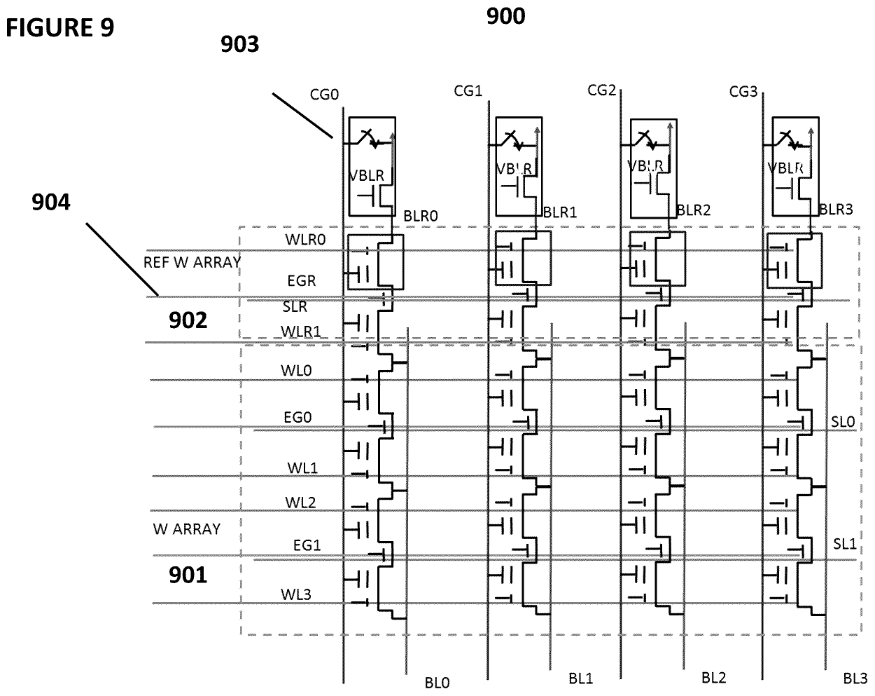

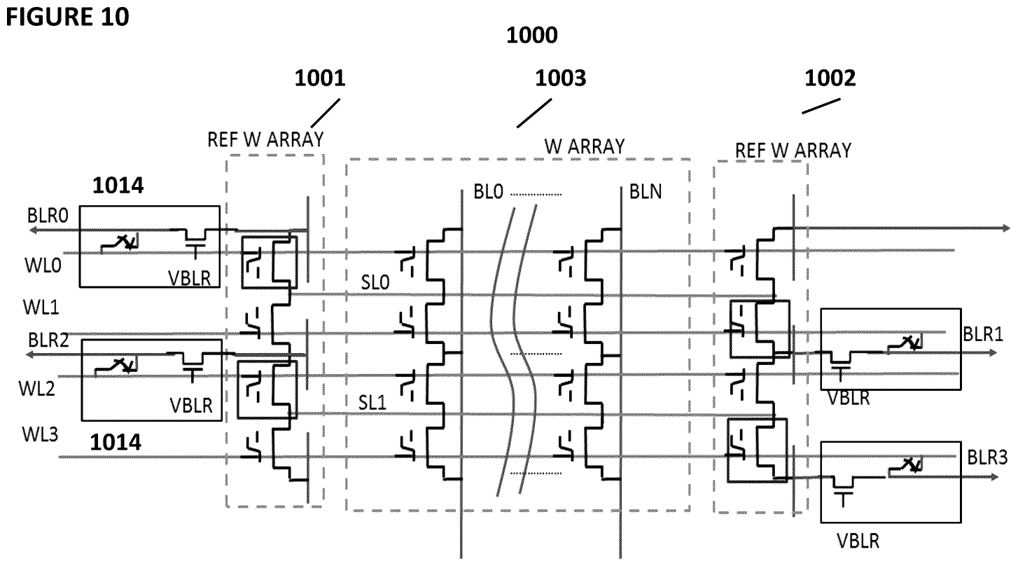

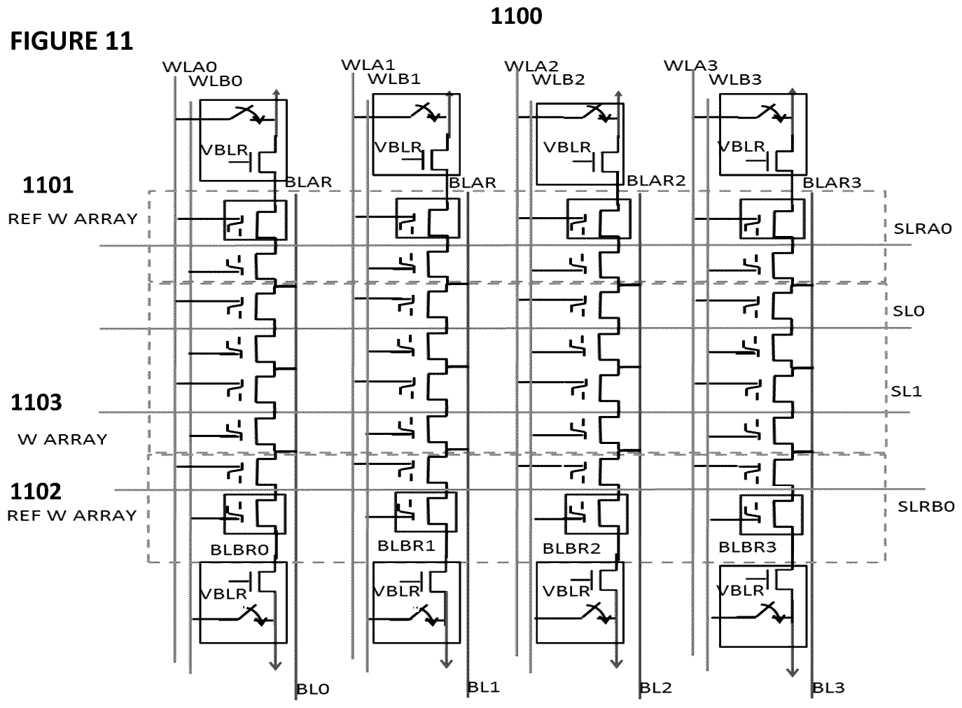

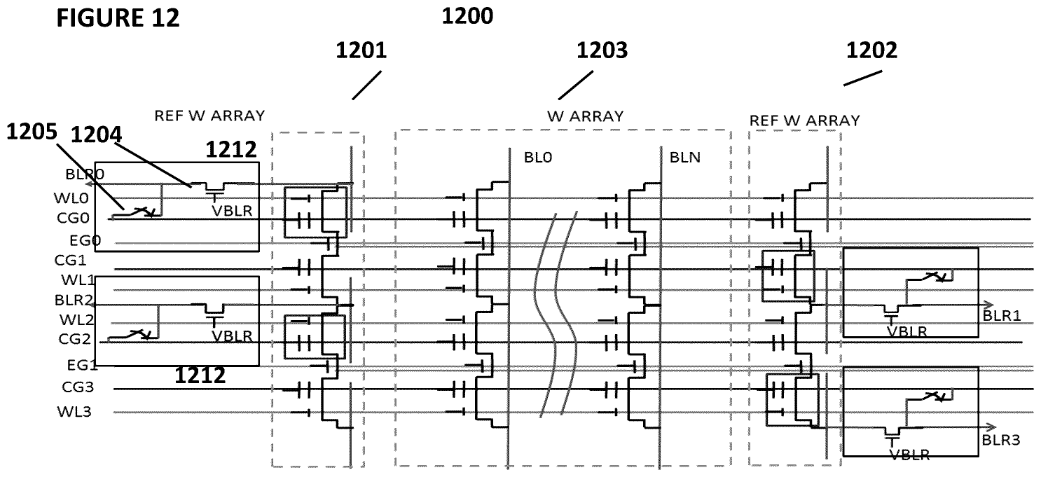

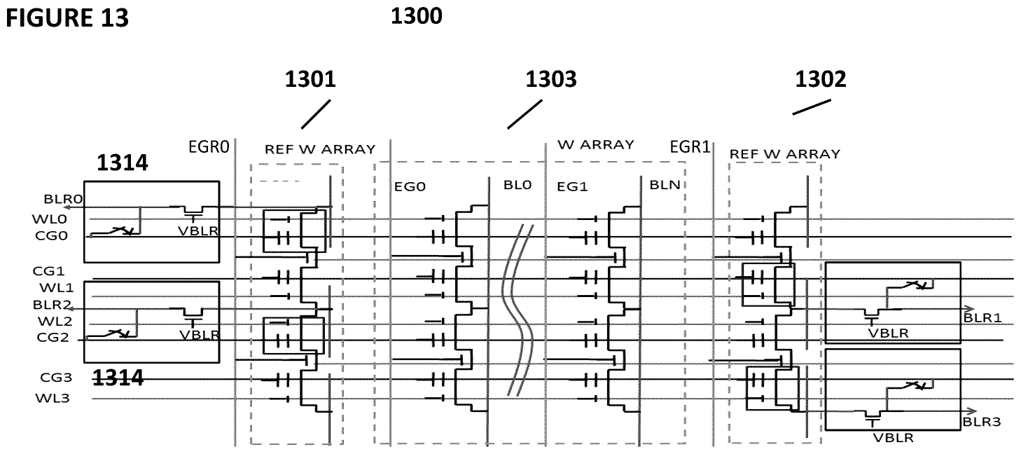

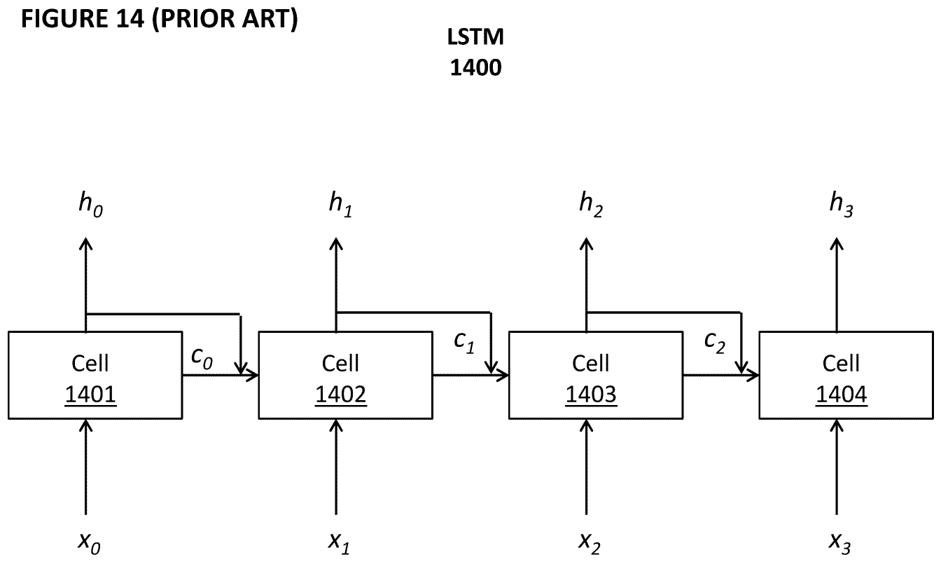

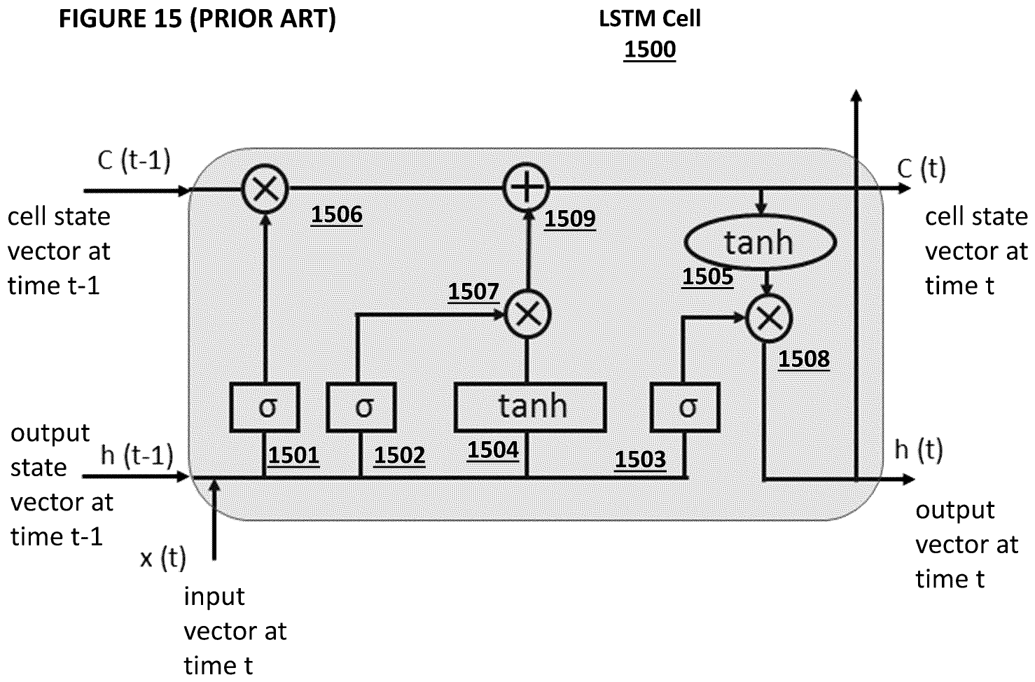

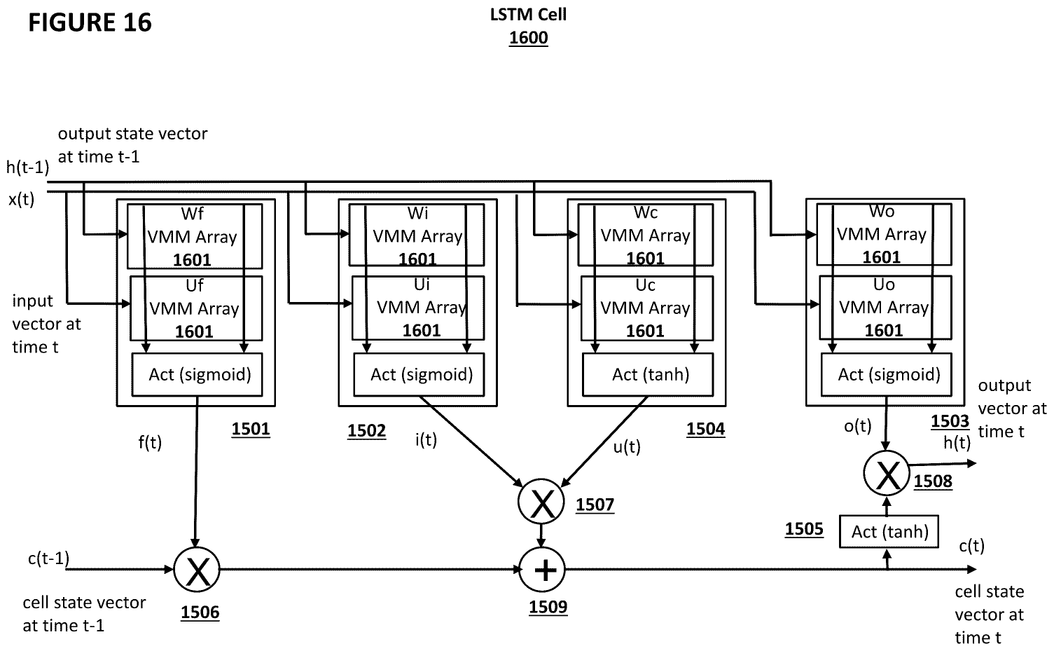

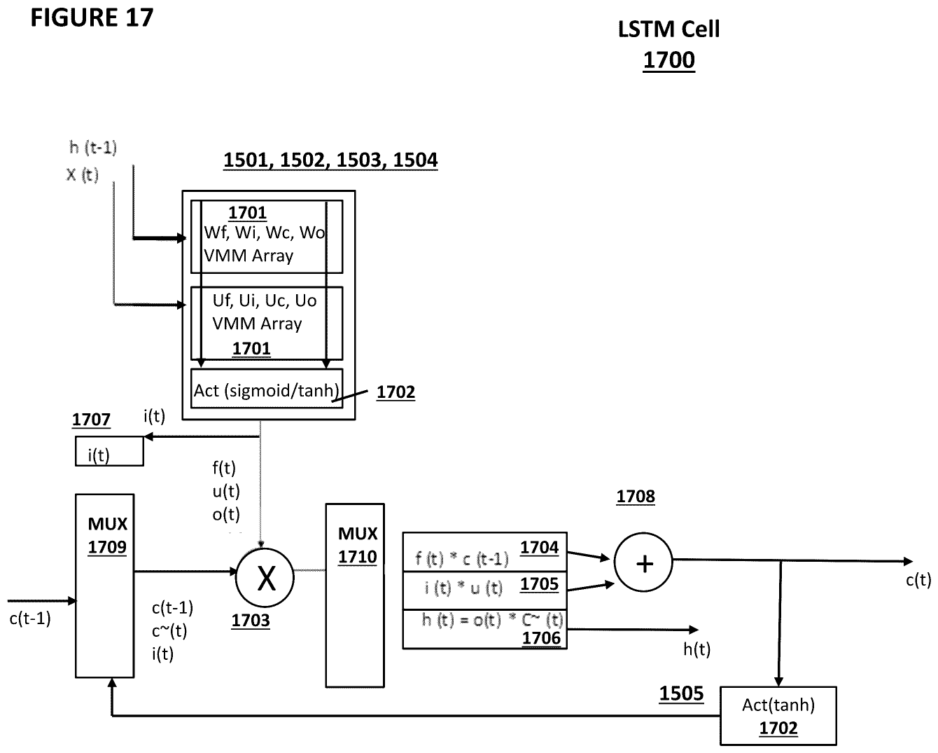

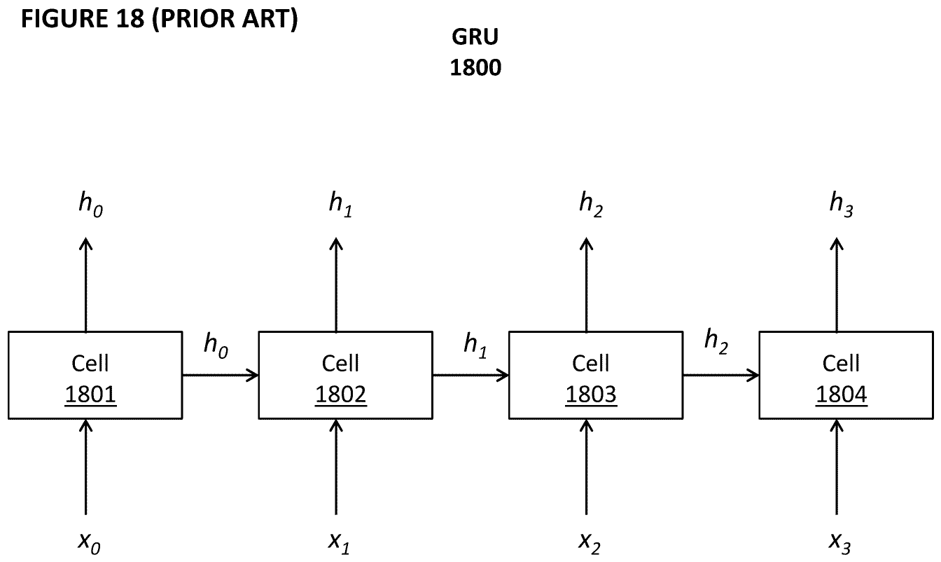

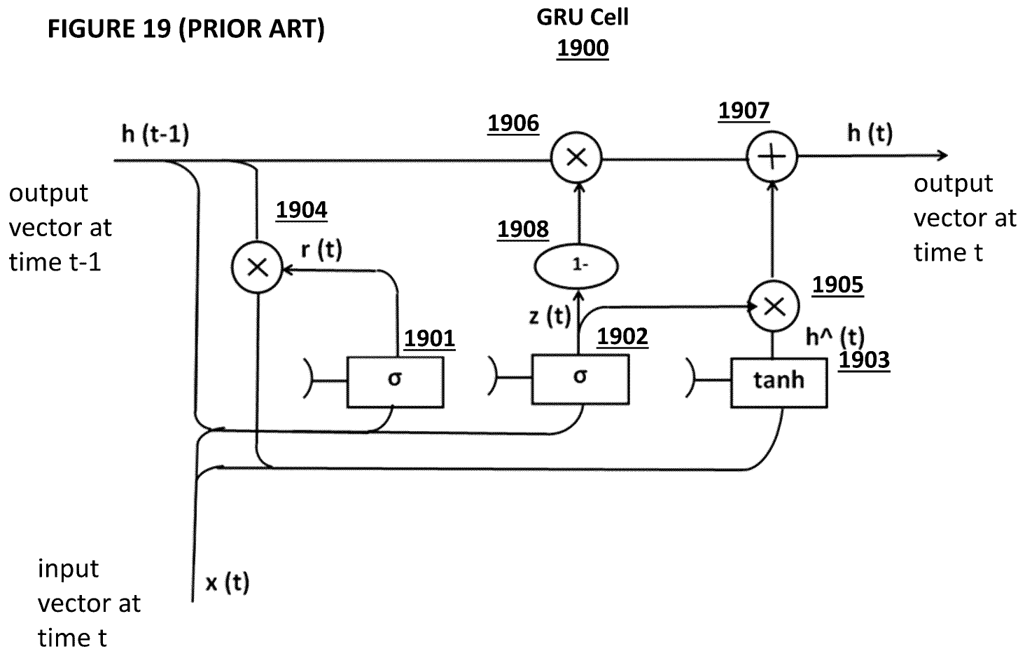

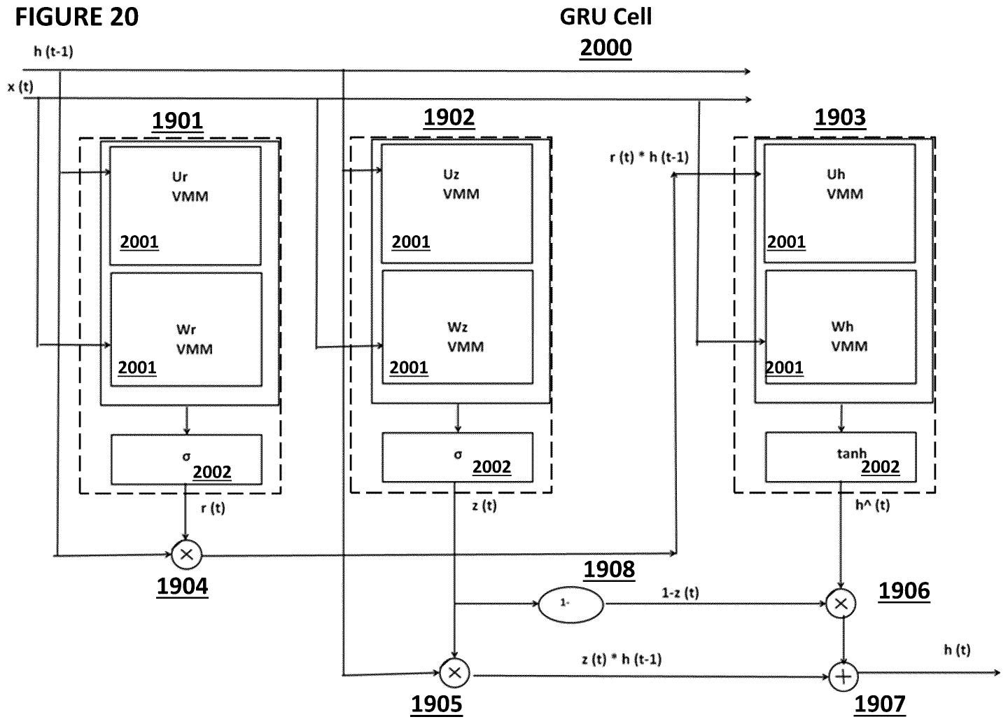

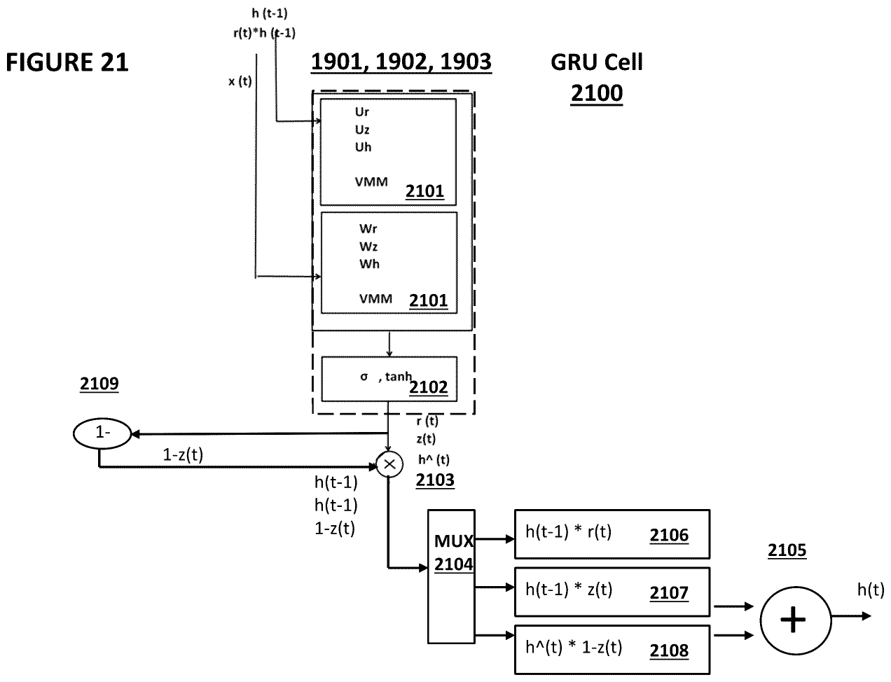

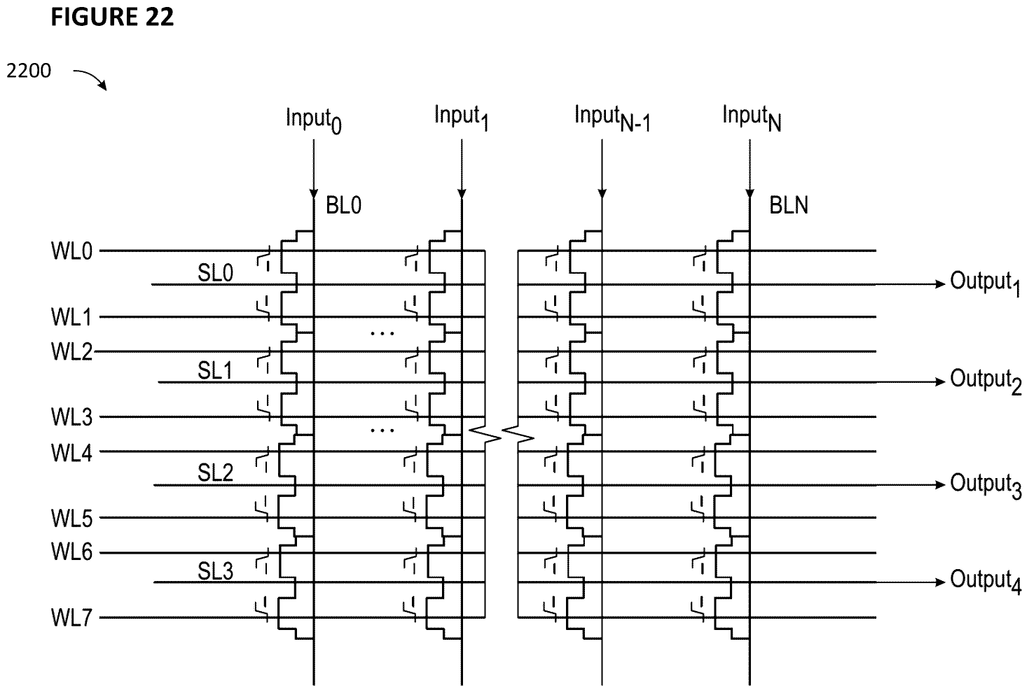

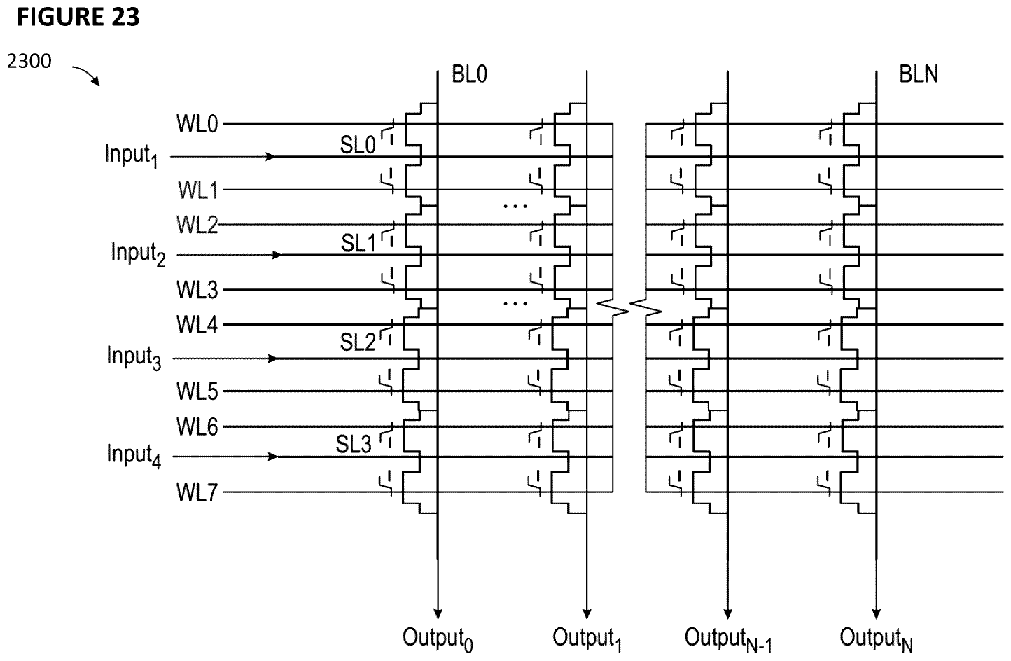

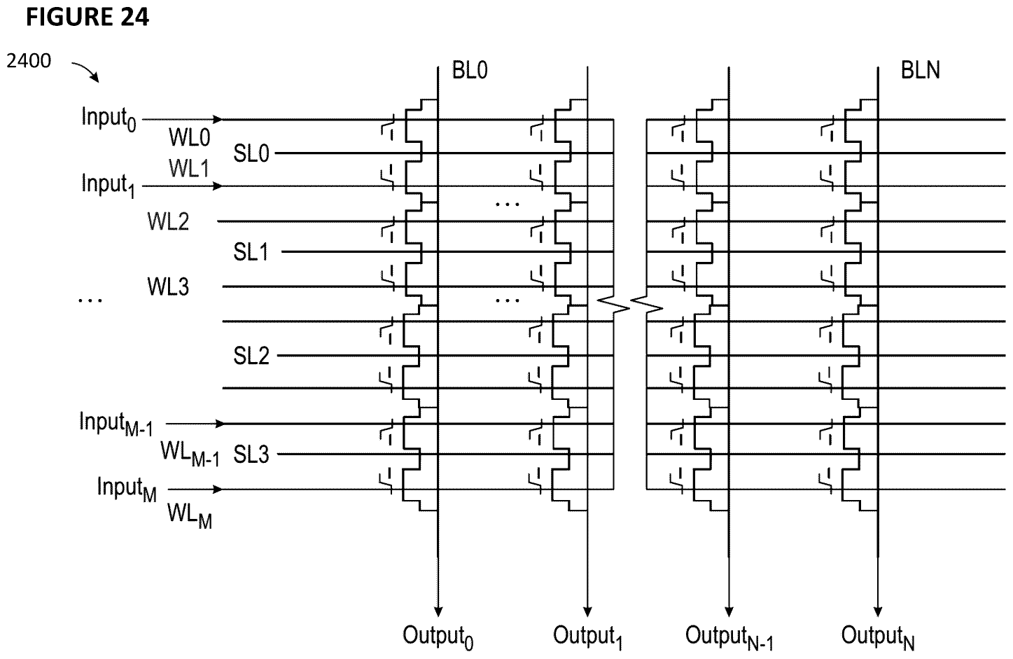

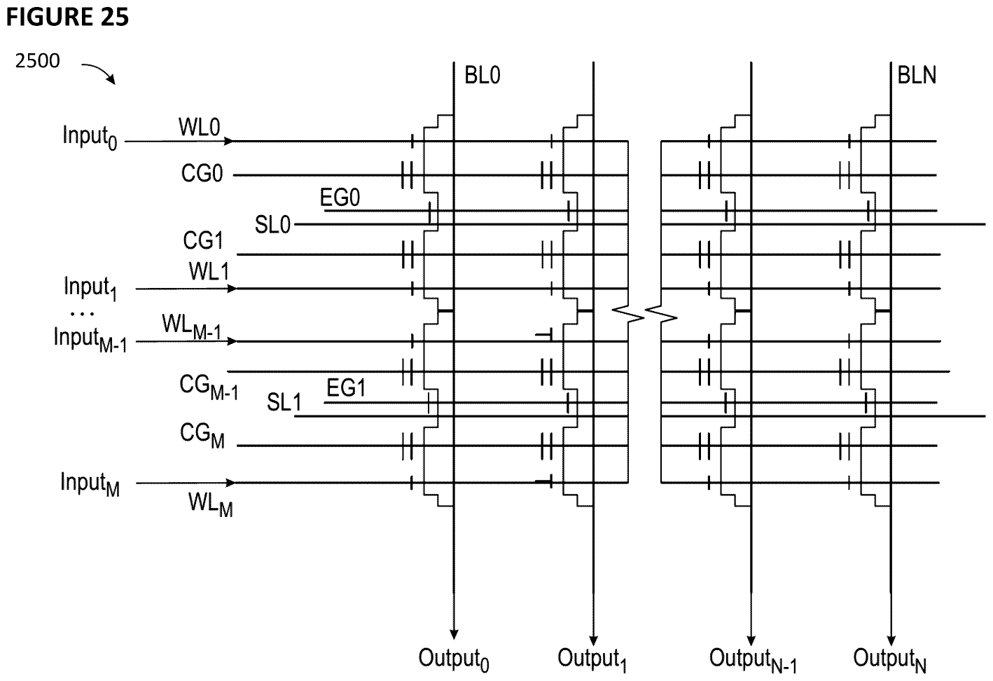

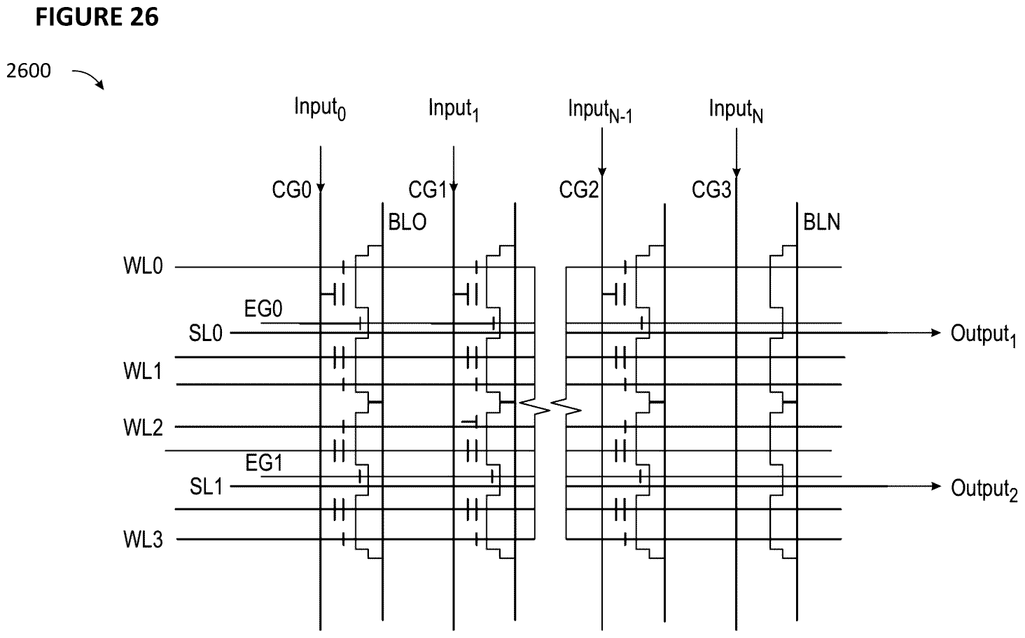

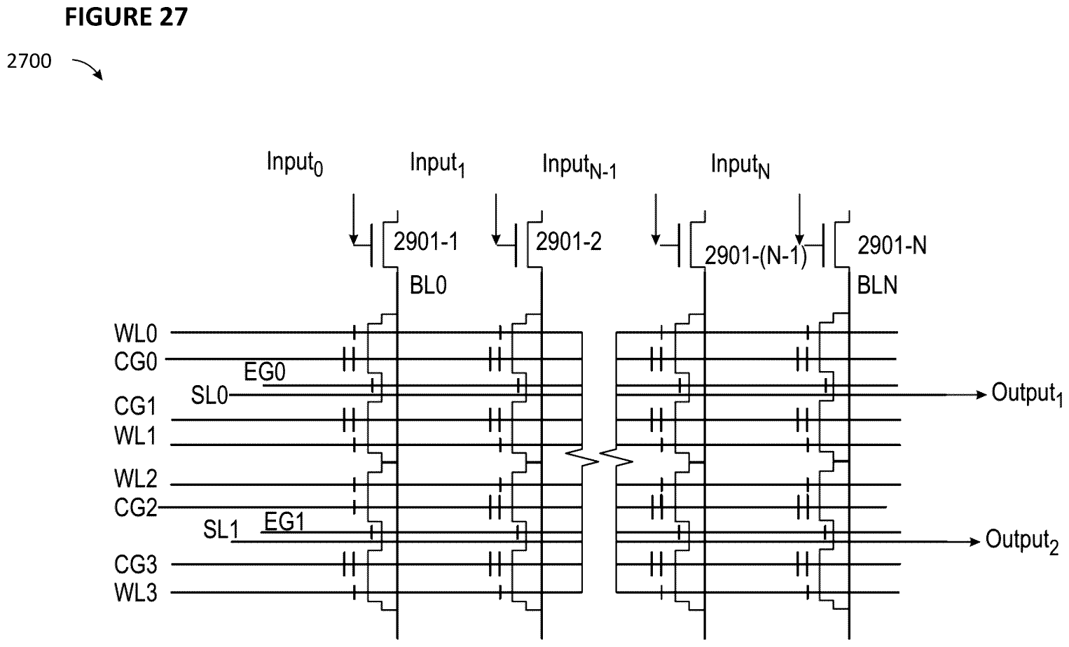

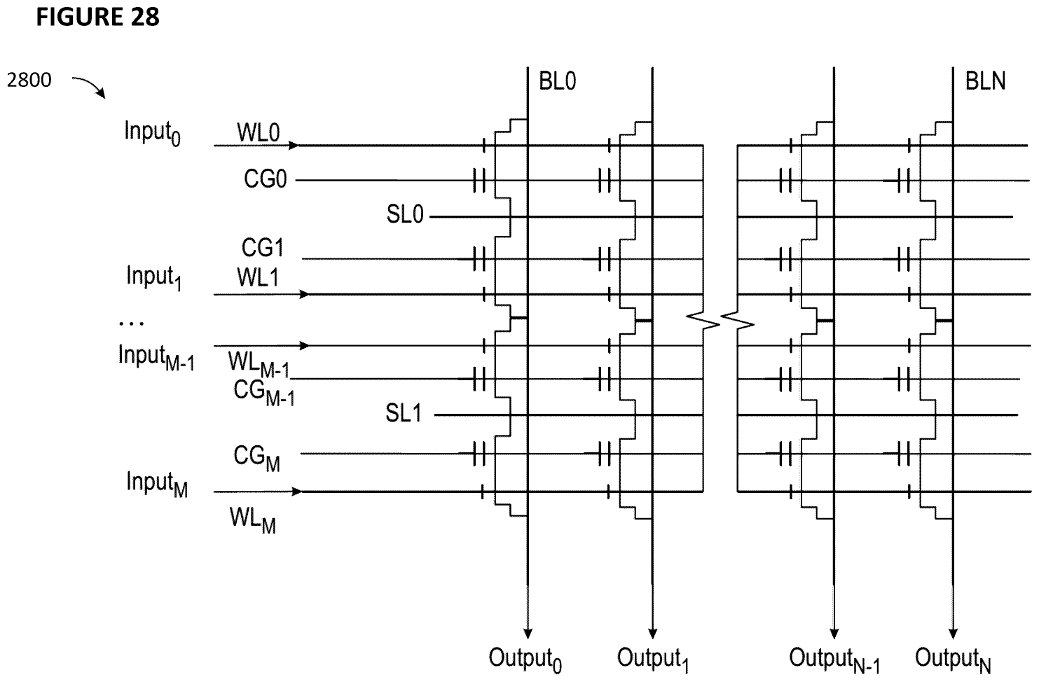

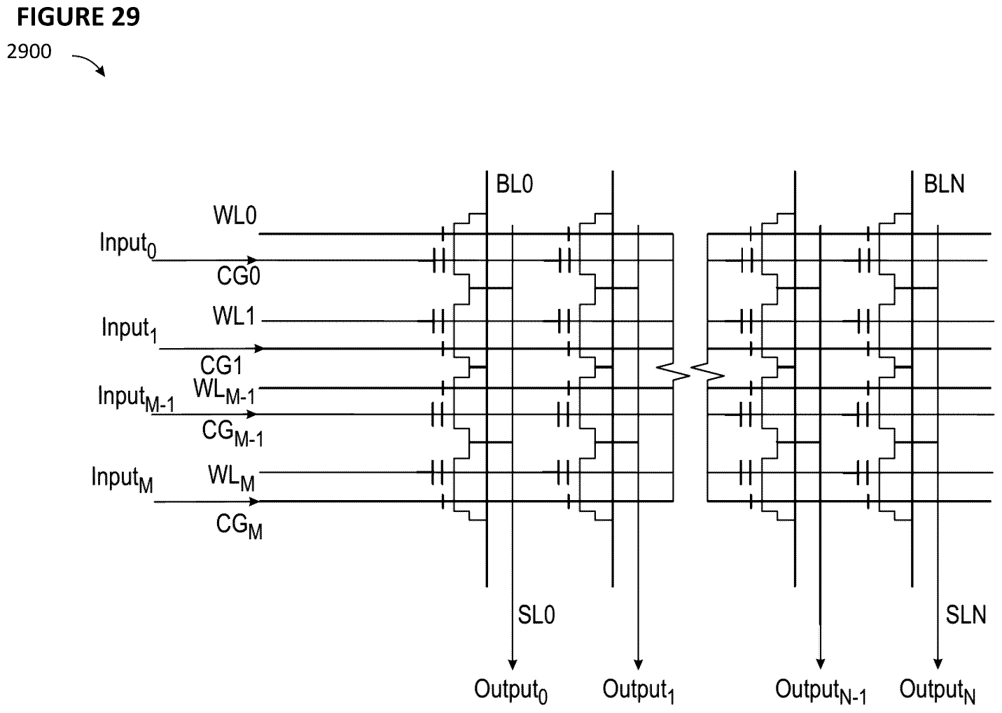

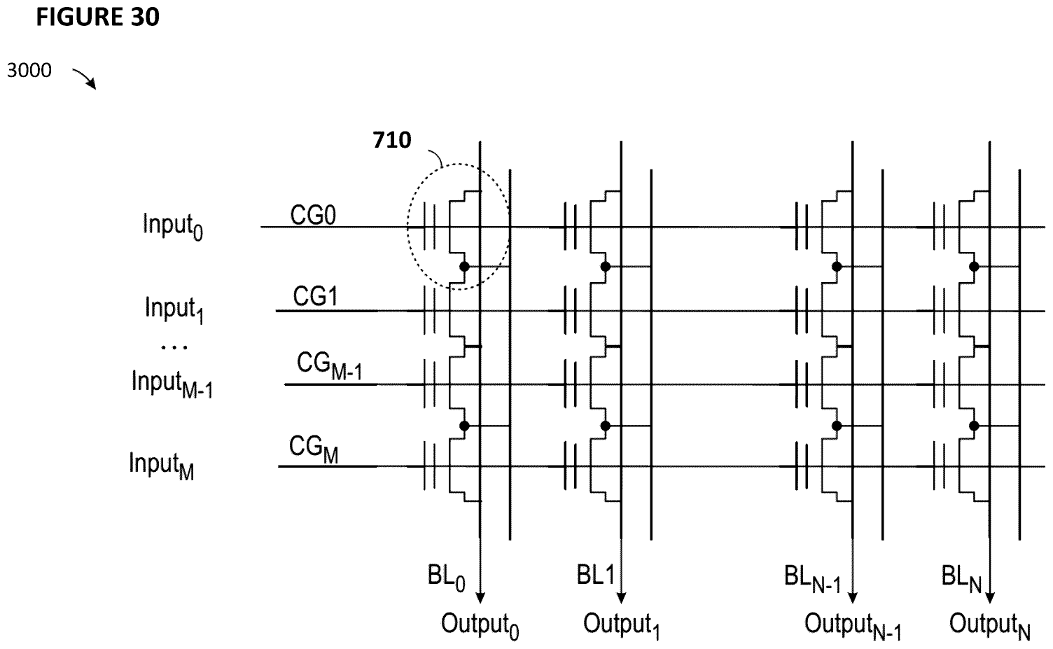

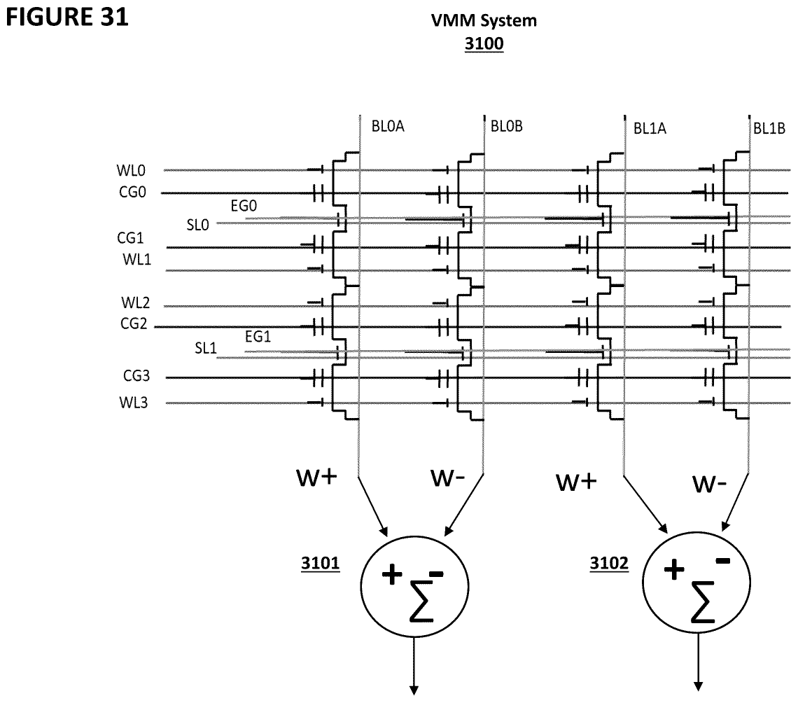

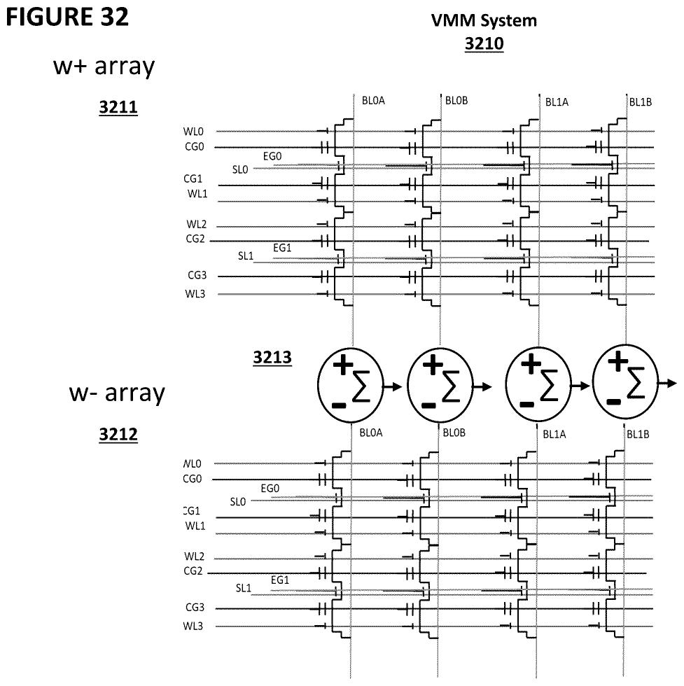

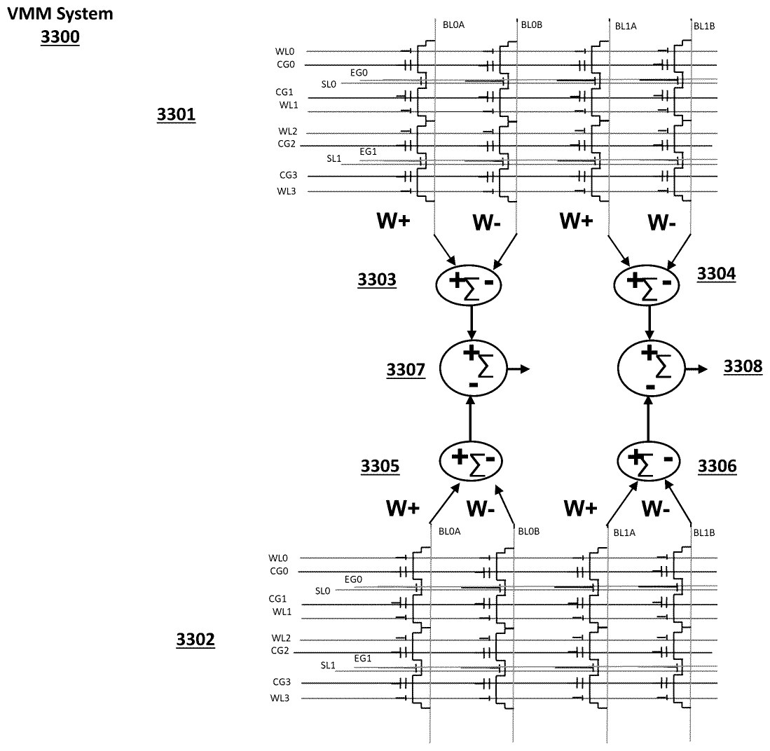

### DETAILED DESCRIPTION OF THE INVENTION

### VMM System Architecture

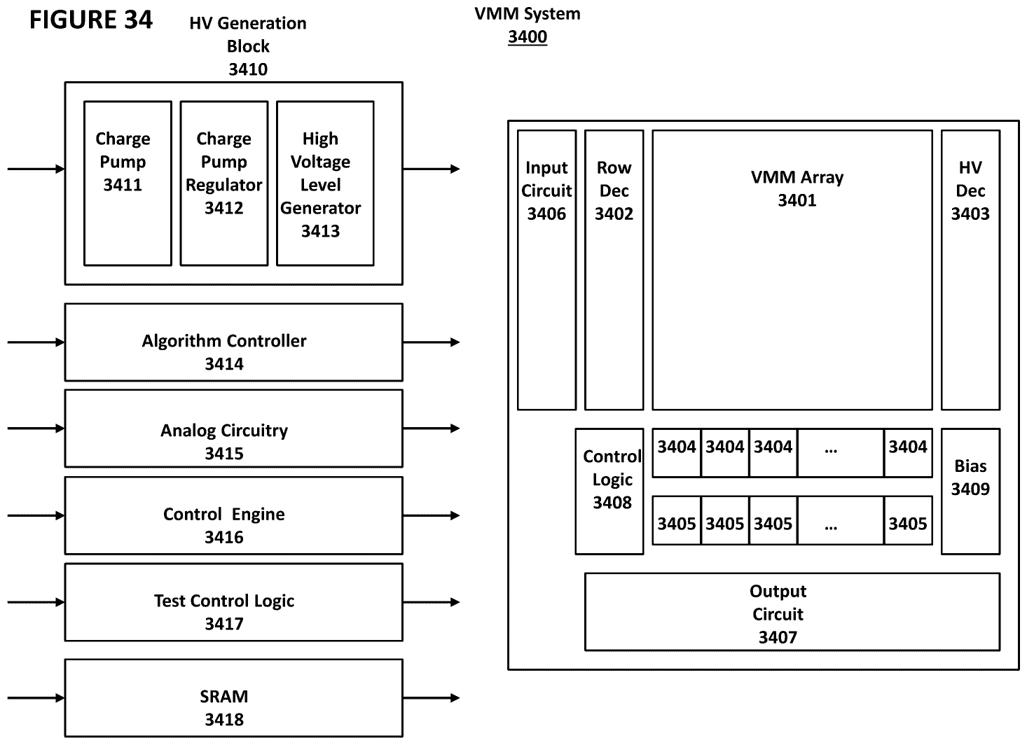

FIG. 34 depicts a block diagram of VMM system 3400. VMM system 3400 comprises VMM array 3401, row decoder 3402, high voltage decoder 3403, column decoders 3404, bit line drivers 3405 (such as bit line control circuitry for programming), input circuit 3406, output circuit 3407, control logic 3408, and bias generator 3409. VMM system 3400 further comprises high voltage generation block 3410, which comprises charge pump 3411, charge pump regulator 3412, and high voltage level generator 3413. VMM system 3400 further comprises (program/erase, or weight tuning) algorithm controller 3414, analog circuitry 3415, control engine 3416 (that may include functions such as arithmetic functions, activation functions, embedded microcontroller logic, without limitation), test control logic 3417, and static random access memory (SRAM) block 3418 to store intermediate data such as for input circuits (e.g., activation data) or output circuits (neuron output data, partial sum output neuron data) or data in for programming (such as data in for a whole row or for multiple rows).

The input circuit 3406 may include circuits such as a DAC (digital to analog converter), DPC (digital to pulses converter, digital to time modulated pulse converter), AAC (analog to analog converter, such as a current to voltage converter, logarithmic converter), PAC (pulse to analog level converter), or any other type of converters. The input circuit 3406 may implement one or more of normalization, linear or non-linear up/down scaling functions, or arithmetic functions. The input circuit 3406 may implement a temperature compensation function for input levels. The input circuit 3406 may implement an activation function such as ReLU or sigmoid. Input circuit 3406 may store digital activation data to be applied as, or combined with, an input signal during a program or read operation. The digital activation data can be stored in registers. Input circuit 3406 may comprise circuits to drive the array terminals, such as CG, WL, EG, and SL lines, which may include sample-and-hold circuits and buffers. A DAC can be used to convert digital activation data into an analog input voltage to be applied to the array.

The output circuit 3407 may include circuits such as an ITV (current-to-voltage circuit), ADC (analog to digital converter, to convert neuron analog output to digital bits), AAC (analog to analog converter, such as a current to voltage converter, logarithmic converter), APC (analog to pulse(s) converter, analog to time modulated pulse converter), or any other type of converters. The output circuit 3407 may convert array outputs into activation data. The output circuit 3407 may implement an activation function such as rectified linear activation function (ReLU) or sigmoid. The output circuit 3407 may implement one or more of statistic normalization, regularization, up/down scaling/gain functions, statistical rounding, or arithmetic functions (e.g., add, subtract, divide, multiply, shift, log) for neuron outputs. The output circuit 3407 may implement a temperature compensation function for neuron outputs or array outputs (such as bitline output) so as to keep power consumption of the array approximately constant or to improve precision of the array (neuron) outputs such as by keeping the IV slope approximately the same over temperature. The output circuit 3407 may comprise registers for storing output data.

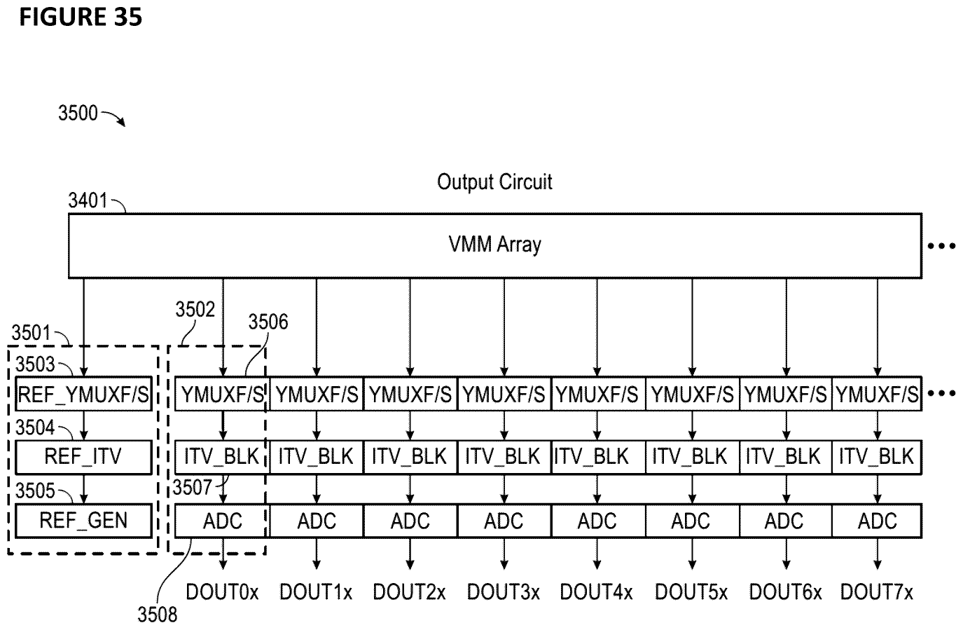

FIG. 35 depicts output circuit 3500. Output circuit 3500 is an example implementation of output circuit 3407 in FIG. 34. Output circuit 3500 comprises reference circuit 3501 and column circuit 3502. A plurality of instantiations of column circuit 3502 are used for a plurality of columns in VMM array 3401, i.e. a respective instantiation of column circuit 3502 for a respective column in VMM array 3401. Eight instantiations of column circuit 3502 are shown in FIG. 35, but it is to be understood that there could be many more instantiations and associated columns in a VMM system.

Reference circuit 3501 receives a reference current, such as a bitline current, from one or more reference columns of non-volatile memory cells. The reference column can be part of VMM array 3401, as shown, or can be located in a separate array. Reference circuit 3501 comprises column multiplexor 3503, current-to-voltage converter 3504, and reference generator 3505. If more than one reference column is connected to reference circuit 3501, then column multiplexor 3503 selects a column and provides the current from that column to current-to-voltage converter 3504, which converts the received current into a voltage. Reference generator 3505 generates voltage references VADCREFs (such as VADCREFH and VADCREFL) used by analog to digital converters (ADCs) 3508, where the voltage references VADCREFs are based on the voltage outputs from current-to-voltage converter 3504. For example, if ADC 3508 is a successive approximation register (SAR) ADC, then reference generator 3505 generates voltages VREFP, VREFN, and VCIM (e.g., VREFP=0.3V, VREFN=0V, VCIM=0.15V for a full-scale input voltage of 0.3V for the ADC). Because the reference voltages for the ADCs 3508 are generated from the voltage output of current-to-voltage converter 3504, which is similar to current-to-voltage converter 3507, resolution of ADCs 3508 is maintained because the reference voltages for the ADCs automatically track any changes due to changes in operating conditions (such as changes in temperature) of current-to-voltage converter 3504 and current-to-voltage converter 3507.

Each column circuit 3502 receives current, such as a bitline current, from one or more columns in VMM array 3401. Each column circuit 3502 comprises column multiplexor 3506, current-to-voltage converter 3507, and ADC 3508. If more than one column is connected to column circuit 3502, then column multiplexor 3506 selects a column and provides the current from that column to current-to-voltage converter 3507, which will convert the received current into a voltage, which ADC 3508 converts into a digital output. For example, column circuit 3502 outputs DOUTOx [n:0]. If a single column is connected to column circuit 3502, column multiplexor 3506 is optional.

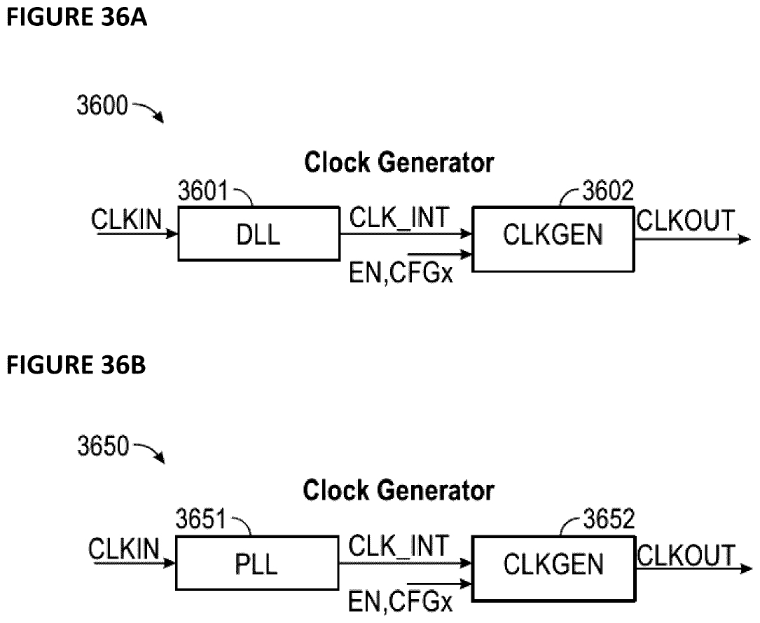

FIGS. 36A and 36B depict clock generators that are used to generate fast clock signals, meaning clock signals with a faster frequency than the system clock received from a source external to the VMM system, for the circuits described herein.

FIG. 36A depicts clock generator 3600, which receives a system clock, CLKIN (for example, the system clock received from a source external to the VMM system), an enable signal, EN, and configuration bits, CFGx, and generates a faster clock, CLKOUT, with a different clock frequency depending on the configuration bits, CFGx, using a delay-lock loop (DLL) 3601 and clock generator block 3602. FIG. 36B depicts clock generator 3650, which receives a system clock, CLKIN, and generates a faster clock, CLKOUT, using a phase-locked loop (PLL) 3651 and clock generator block 3602. DLL 3601 and PLL 3651 are used to generate precise clocks, respectively faster than system clock CLKIN, that synchronize with input clock CLKIN, for example, clocks that are 2-100 times faster than the input system clock CLKIN. Clock generator blocks 3602 and 3652 are used to generate different clock frequencies in response to configuration bits CFGx using CLK_INT.

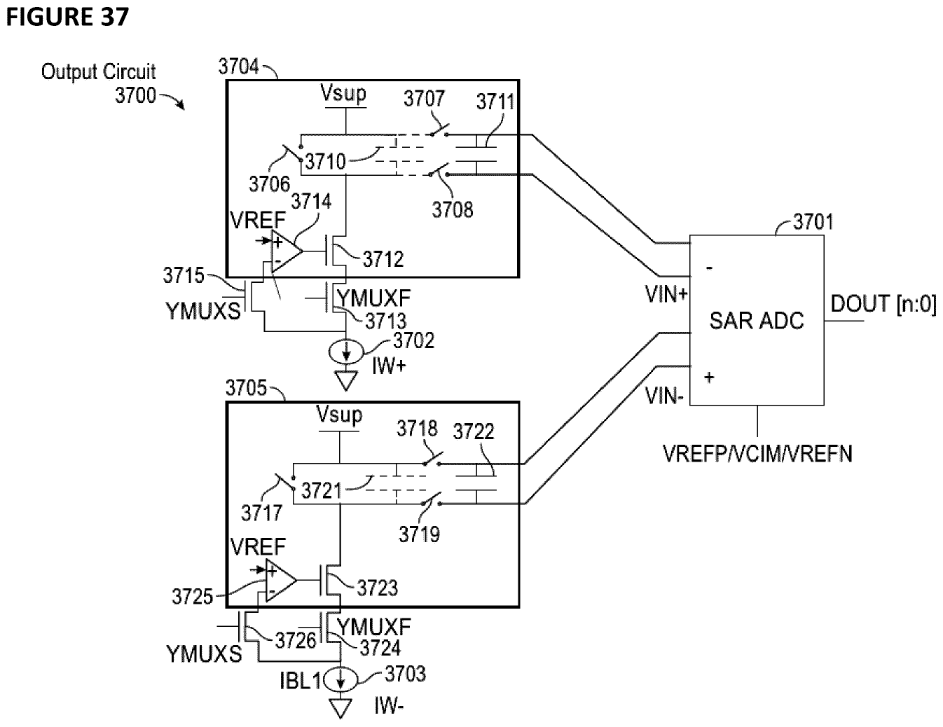

FIG. 37 depicts output circuit 3700, which can be used for an instantiation of column circuit 3502 in FIG. 35. Output circuit 3700 is a differential circuit, meaning the circuit output is a function of two inputs. Output circuit 3700 comprises current-to-voltage converter (ITV) 3704 (a first current-to-voltage converter), ITV 3705 (a second current-to-voltage converter), differential input serial approximation register analog-to-digital converter (SAR ADC) 3701, transistors 3713, 3715, 3724, and 3726 (which form a portion of a column multiplexor, which couples a column in a first set of columns to ITV 3704 and couples a column in the second set of columns to ITV 3705), and current sources 3702 and 3703. Current source 3702 represents current drawn by a column in VMM array 3401 that is selected by the column multiplexor, where the column stores W+ values. Current source 3703 represents current drawn by a column in VMM array 3401 that is selected by the column multiplexor, where the column stores W− values. Output circuit 3700 receives current IW+(a first current) and IW− (a second current) from two differential columns, W+ and W−, respectively, and outputs a digital output, DOUT, indicative of those currents, which is equivalent to W=W+−W−.

In one alternative, output circuit 3700 can be implemented as a single ended circuit, meaning that one ITV (3704 or 3705) and a single input ADC is used. In another alternative, a differential output can be achieved by using two sets of the ITVs and a single input ADC can be formed by combining the two results. In another alternative, a differential output can be achieved by performing time multiplexing and using the ITV and a single input ADC by combining the two results in time.

ITV 3704 comprises switches 3706, 3707, and 3708; integration capacitors 3710 and 3711; NMOS cascoding transistor 3712; and operational amplifier 3714. Prior to a read operation, switches 3706, 3707, and 3708 are closed, resulting in the top and bottom plates of integration capacitors 3710 and 3711 being charged to Vsup and VIN+ equal to Vsup. During an integration period, switch 3706 is opened. Current source 3702 draws current, resulting in the voltage of VIN+ (a first voltage) being pulled downward in proportion to the current drawn by current source 3702. That is, VIN+ will equal the initial value of VIN+ before the read operation minus a first discharge value due to the first current, IW+. After the integration period, the voltages across the capacitors 3710 and 3711 are sampled into the SAR ADC 3701. After this sampling period, the ADC will start to do conversion of this sampled voltages into digital output bits. In one example, the voltages on one or more of capacitor 3710 and capacitor 3711 are buffered before going to the SAR ADC 3701 In another example, capacitor 3711 is a capacitor in the binary capacitor array of the SAR ADC 3701 (that is, ITV 3704 and SAR ADC 3701 share a capacitor to save die space). In this case, after the integration period, switches 3707 and 3708 are opened, and SAR ADC 3701 starts the conversion of voltages on capacitor 3711 into digital output bits.

Similarly, ITV 3705 comprises switches 3717, 3718, and 3719; capacitors 3721 and 3722; NMOS cascoding transistor 3723; and operational amplifier 3725. Prior to a read operation, switches 3717, 3718, and 3719 are closed, resulting in the top and bottom plates of integration capacitors 3721 and 3722 being charged to Vsup and VIN− equal to Vsup. During an integration period, switch 3717 is opened. Current source 3703 will draw current, resulting in the voltage of VIN− (a second voltage) being pulled downward in proportion to the current drawn by current source 3703. That is, VIN− will equal the initial value of VIN− before the read operation minus a first discharge value due to the first current, IW−. Capacitors 3721 and 3722 are similar to capacitors 3710 and 3711 in the ITV 3704. Switches 3718 and 3719 are similar to switches 3707 and 3708 in ITV 3704. The operation of ITV 3705 is similar to that of ITV 3704 for the current IW−.

Bitline regulation circuit for the ITV 3704 includes the operational amplifier 3714, transistor 3712, and transistors 3713 and 3715 which are both turned on when a read operation is desired for the bit line IW+. This circuit imposes a fixed bias on a bitline during a read operation. Specifically, it imposes VREF, which is applied to the positive input terminal of operational amplifier 3714, on the bit line during a read operation irrespective of the magnitude of the current drawn by bit line IW+.

Similarly, bitline regulation circuit for the ITV 3705 includes the operational amplifier 3725, transistor 3723, and force and sense transistors 3724 and 3726 which are both turned on when a read operation is desired for the bit line IW−. This circuit imposes VREF, which is applied to the positive input terminal of operational amplifier 3725, on the bit line during a read operation irrespective of the magnitude of the current drawn by bit line IW+

SAR ADC 3701 receives differential voltages VIN+ and VIN− and reference voltages VADCREFH and VADCREFL and generates a digital output, DOUT[n:0], based on the difference between VIN+ and VIN−.

Notably, integration capacitors 3710 and 3721 will require significant die space since they will be relatively large. Optionally, integration capacitors 3711 and 3722 are re-used from the capacitor arrays of the SAR ADC 3701 to save area within the die. When the SAR ADC 3701 starts the conversion, switches 3707, 3708, 3718, and 3719 are opened.

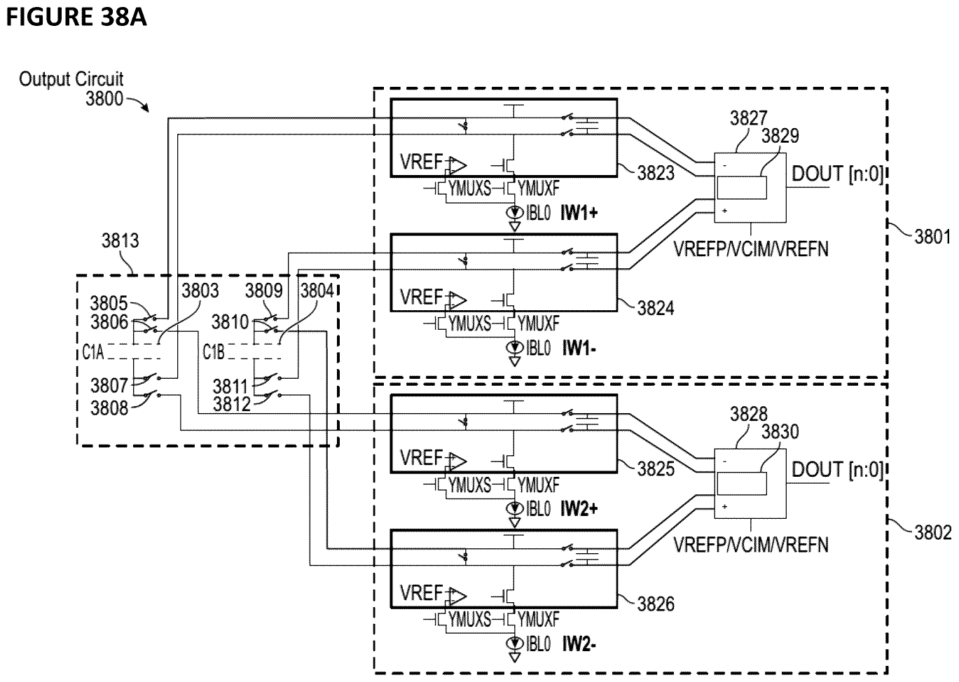

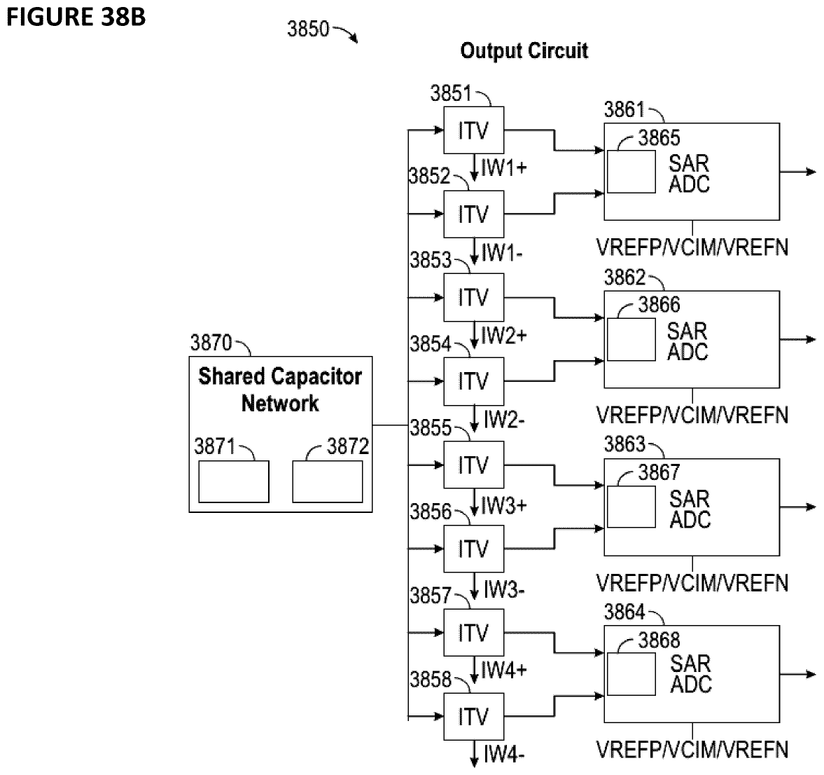

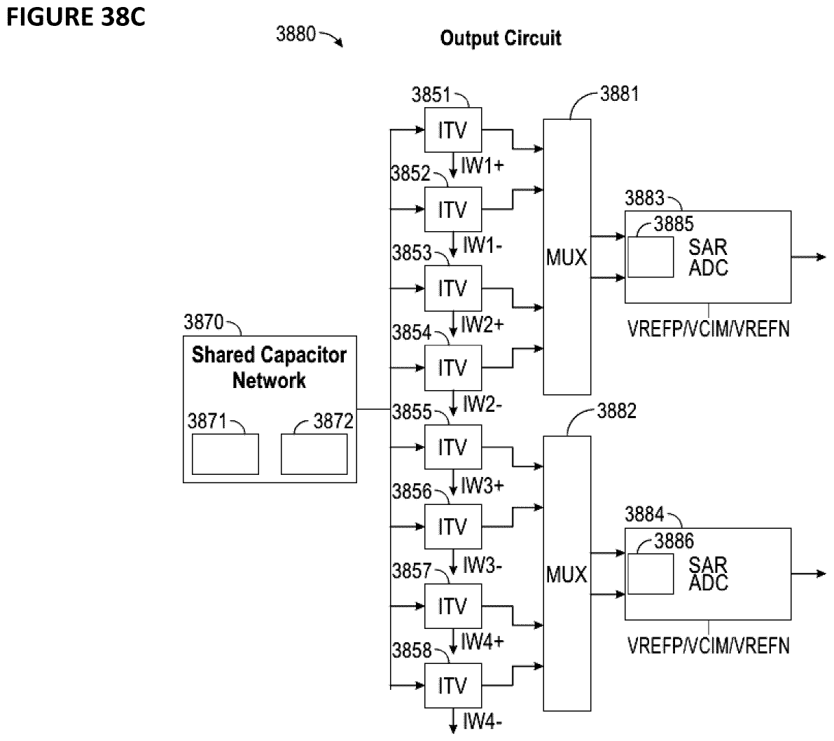

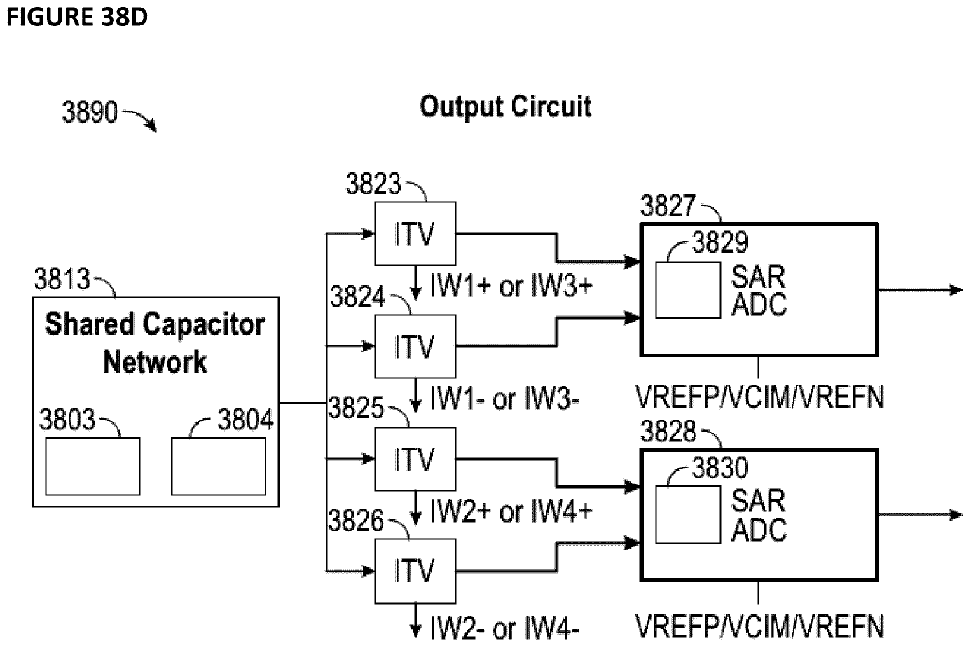

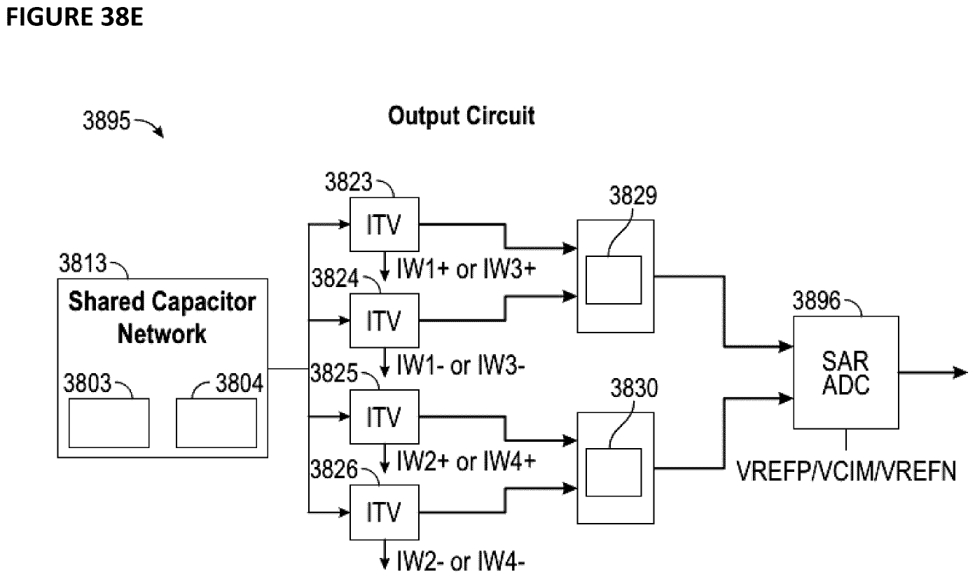

FIG. 38A depicts output circuit 3800, which can be used for two instantiations of column circuit 3502 in FIG. 35. Output circuit 3800 comprises circuit 3801, circuit 3802, and shared capacitor network 3813. Circuits 3801 and 3802 each are identical to output circuit 3700 in FIG. 37 except that integration capacitors 3710 and 3721 in output circuit 3700 have been replaced by shared integration capacitors 3803 (a first integration capacitor) and 3804 (a second integration capacitor), respectively, in shared capacitor network 3813; and switches 3805, 3807, 3809, and 3811 used in shared capacitor network 3813 for circuit 3801; and switches 3806, 3808, 3810, and 3812 are used in shared capacitor network 3813 for circuit 3802. Circuit 3801 comprises ITV 3823 (a first current to voltage converter) coupled to IW1+ (a first current) and ITV 3824 (a second current to voltage converter) coupled to IW1− (a second current). Circuit 3802 comprises ITV 3825 (a third current to voltage converter) coupled to IW2+ (a third current) and ITV 3826 (a fourth current to voltage converter) coupled to IW2− (a fourth current). This design uses two fewer capacitors compared to using two instantiations of output circuit 3700 in FIG. 37.

ITV 3823 generates a first voltage and ITV 3824 generates a second voltage and are coupled to SAR ADC 3827 (a first SAR ADC) comprising CDAC 3829. ITV 3825 generates a third voltage and ITV 3826 generates a fourth voltage and are coupled to SAR ADC 3828 (a second SAR ADC) comprising CDAC 3830. During a read operation, the first voltage will be equal to an initial voltage (the voltage on that same node before the read operation) minus a first discharge value due to IW1+, the second voltage will be equal to an initial voltage (the voltage on that same node before the read operation) minus a second discharge value due to IW1−, the third voltage will be equal to an initial voltage (the voltage on that same node before the read operation) minus a third discharge value due to IW2+, and the fourth voltage will be equal to an initial voltage (the voltage on that same node before the read operation) minus a fourth discharge value due to IW2−.

Thus, shared integration capacitor 3803 (a first integration capacitor) is shared in a time-multiplexed manner by ITV 3823 and ITV 3826, and shared integration capacitor is shared in a time-multiplexed manner by ITV 3824 and ITV 3826.

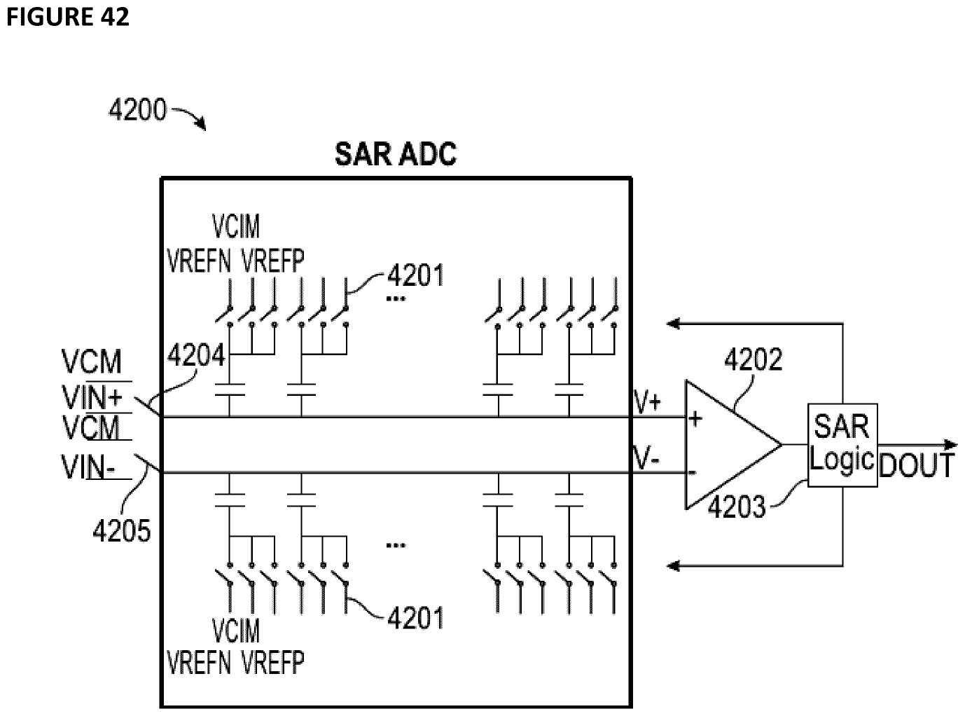

FIG. 38B depicts output circuit 3850, which can be used for four instantiations of column circuit 3502 in FIG. 35. Output circuit 3850 has the same design as output circuit 3800 but with 8 ITVs instead of 4 ITVs and 4 SAR ADCs instead of 2 SAR ADCs, using shared capacitor network 3870 that comprises shared capacitors 3871 and 3872 and a series of switches to selectively coupled shared capacitors 3871 and 3872 to ITVs 3851, 3852, 3853, 3854, 3855, 3856, 3857, and 3858. ITV 3851 is coupled to bit line current IW1+ (a first current), ITV 3852 is coupled to bit line current IW1− (a second current), ITV 3853 is coupled to bit line current IW2+(a third current), ITV 3854 is coupled to bit line current IW2− (a fourth current), ITV 3855 is coupled to bit line current IW3+ (a fifth current), ITV 3856 is coupled to bit line current IW3− (a sixth current), ITV 3857 is coupled to bit line IW4+ (a seventh current), and ITV 3858 is coupled to bit line current IW4− (an eighth current). ITVs 3851 and 3852 are coupled to SAR ADC 3861, ITVs 3853 and 3854 are coupled to SAR ADC 3862, ITVs 3855 and 3856 are coupled to SAR ADC 3863, and ITVs 3857 and 3858 are coupled to SAR ADC 3864, SAR ADC 3861 comprises binary capacitor array (CDAC) 3865, SAR ADC 3862 comprises CDAC 3866, SAR ADC 3863 comprises CDAC 3867, and SAR ADC 3864 comprises CDAC 3868. The design of the CDACs is described in greater detail below with reference to FIG. 42.

FIG. 38C depicts output circuit 3880, which can be used for four instantiations of column circuit 3502 in FIG. 35. Output circuit 3880 is identical to output circuit 3850 in FIG. 38B except that it uses two SAR ADCs (SAR ADCs 3883 and 3884 containing CDACs 3885 and 3886, respectively) instead of four SAR ADCs, which is achieved by the addition of multiplexor 3881, which allows signals from ITVs 3851 and 3852 to be time-multiplexed with signals from ITVs 3853 and 3854 to share SAR ADC 3883, and the addition of multiplexor 3882, which allows signals from ITVs 3855 and 3856 to be time-multiplexed with signals from ITVs 3857 and 3858 to share SAR ADC 3884.

FIG. 38D depicts output circuit 3890, which is identical to output circuit 3800 in FIG. 38A except that each ITV can be selectively coupled to one of two different bit lines by switches or a multiplexor (not shown). ITV 3823 can be coupled to IW1+ (a first current) or W3+ (a fifth current), ITV 3824 can be coupled to IW1− (a second current) or W3− (a sixth current), ITV 3825 can be coupled to W2+ (a third current) or W4+ (a seventh current), and ITV 3826 can be coupled to W2− (a fourth current) or W4− (an eighth current).

FIG. 38E depicts output circuit 3895, which is similar to output circuit 3890 except the two CDACs 3829 and 3830 are used within a single SAR ADC 3896.

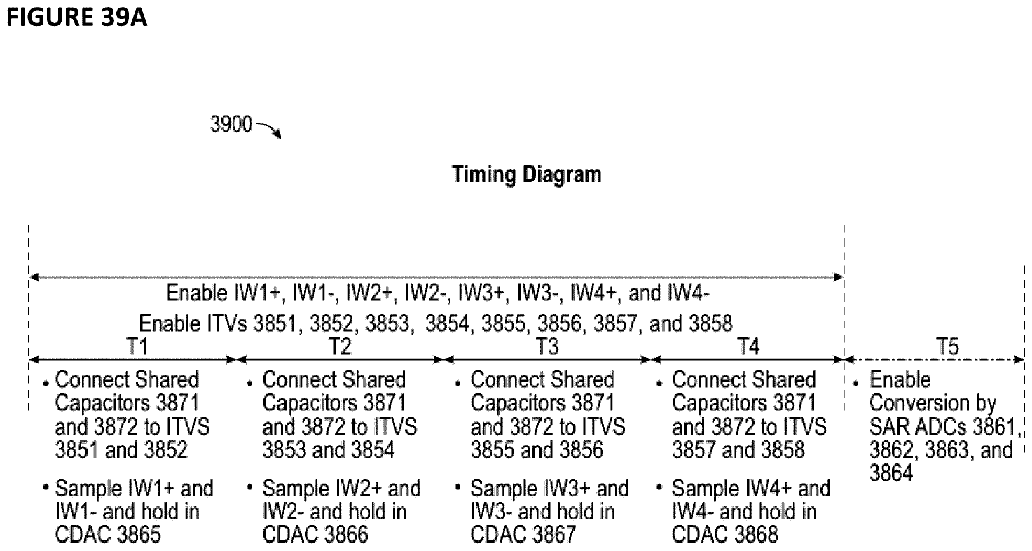

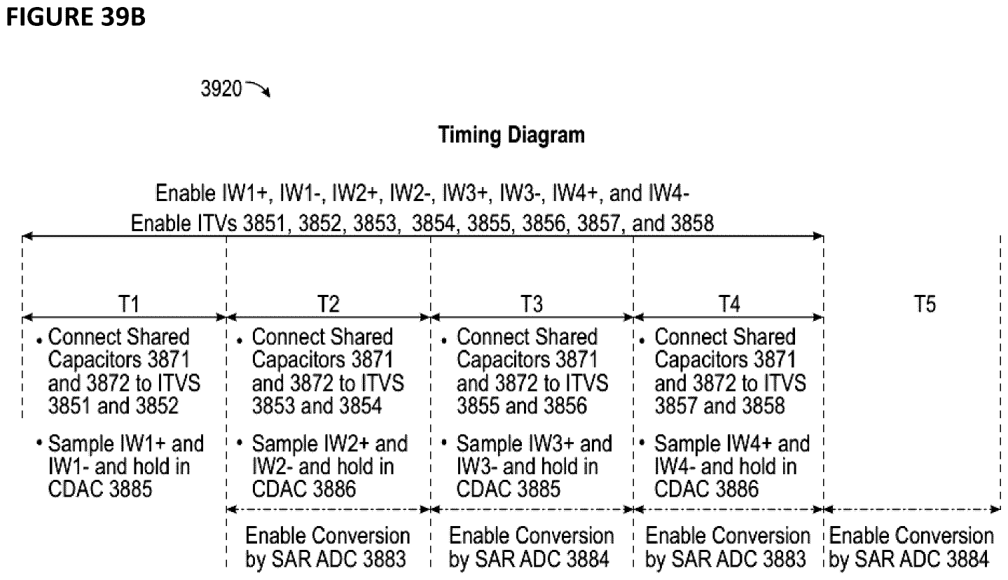

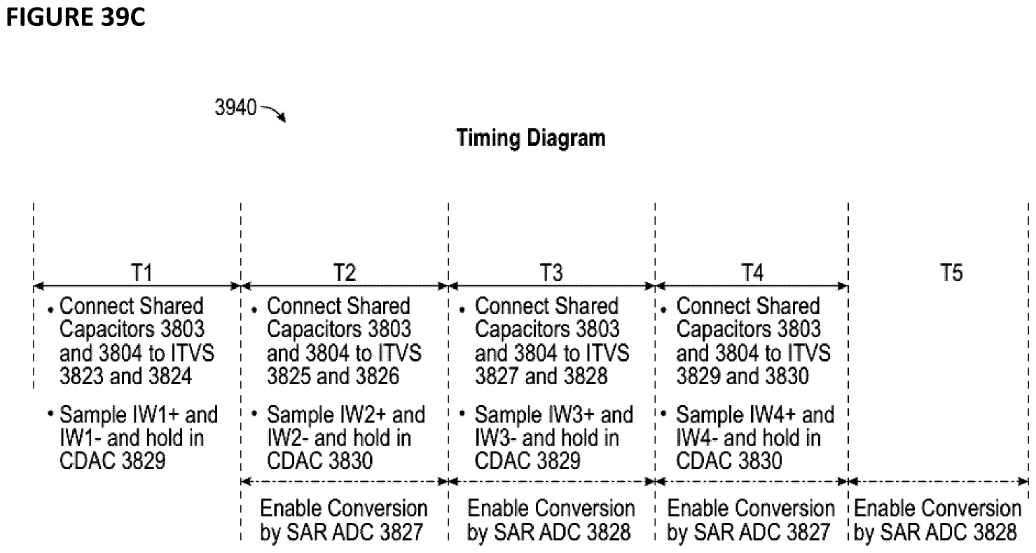

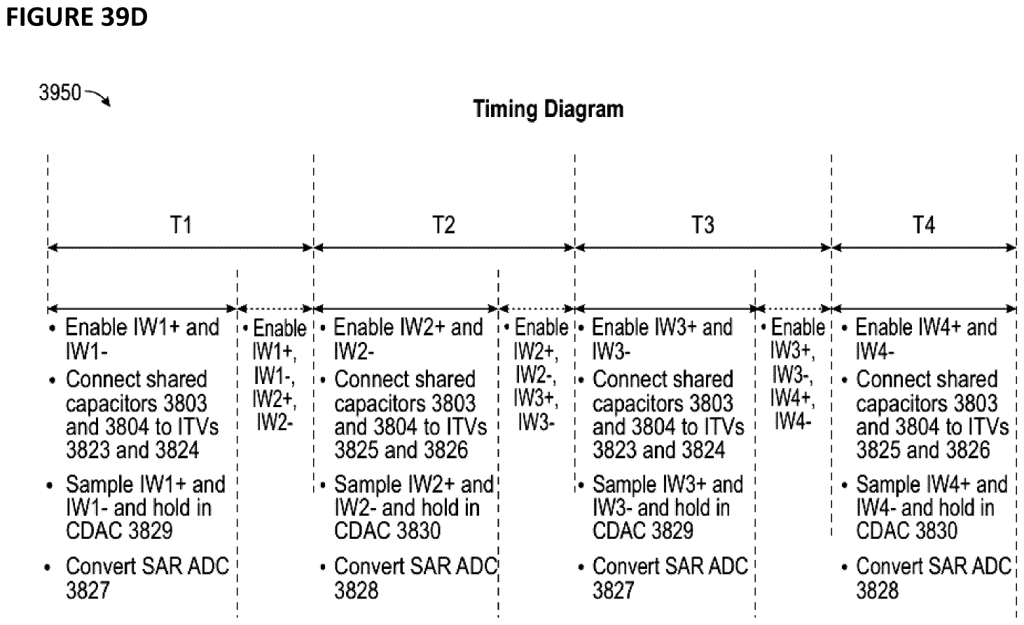

FIG. 39A depicts timing diagram 3900 for operating output circuit 3850, which contains eight ITVs and four SAR ADCs. There are two main periods.

The first period is the integration or sampling period (comprising sub-periods t1, t2, t3, and t4) where bitline current is integrated by the capacitors.

During sub-period t1 of the first period, shared capacitors 3871 and 3872 are coupled to ITVs 3851 and 3852 and bitlines IW1+ and IW1− are sampled and held in CDAC 3865.

During sub-period t2 of the first period, shared capacitors 3871 and 3872 are coupled to ITVs 3853 and 3854 and bitlines IW2+ and IW2− are sampled and held in CDAC 3866.

During sub-period t3 of the first period, shared capacitors 3871 and 3872 are coupled to ITVs 3855 and 3856 and bitlines IW3+ and IW3− are sampled and held in CDAC 3867.

During sub-period t4 of the first period, shared capacitors 3871 and 3872 are coupled to ITVs 3857 and 3858 and bitlines IW4+ and IW4− are sampled and held in CDAC 3868.

The second period (comprising sub-period t5) is the conversion operation of SAR ADCs 3861, 3862, 3863, and 3864 using the voltages stored in CDACs 3865, 3866, 3867, and 3868, respectively.

FIG. 39B depicts timing diagram 3920 for operating output circuit 3880 in FIG. 38C, which contains eight ITVs and two SAR ADCs. As can be seen, there is a ping-pong action between the sampling of the ITVs and conversion of the SAR ADCs, where sampling-and-holding occurs on one CDAC while conversion is performed on the other CDAC.

During sub-period t1, shared capacitors 3871 and 3872 are coupled to ITVs 3851 and 3852 and bitlines IW1+ and IW1− are sampled and held in CDAC 3885.

During sub-period t2, shared capacitors 3871 and 3872 are coupled to ITVs 3853 and 3854 and bitlines IW2+ and IW2− are sampled and held in CDAC 3886. SAR ADC 3883 performs a conversion operation on the value stored in CDAC 3885 during sub-period t1.

During sub-period t3, shared capacitors 3871 and 3872 are coupled to ITVs 3855 and 3856 and bitlines IW3+ and IW3− are sampled and held in CDAC 3885. SAR ADC 3884 performs a conversion operation on the value stored in CDAC 3886 during sub-period t2.

During sub-period t4, shared capacitors 3871 and 3872 are coupled to ITVs 3857 and 3858 and bitlines IW4+ and IW4− are sampled and held in CDAC 3886. SAR ADC 3883 performs a conversion operation on the value stored in CDAC 3885 during sub-period t3.

During sub-period t5, SAR ADC 3884 performs a conversion operation on the value stored in CDAC 3886 during sub-period t4.

FIG. 39C depicts timing diagram 3940 for operating output circuit 3800 in FIG. 38A, which contains four ITVs and two SAR ADCs, where sampling-and-holding occurs on one CDAC while conversion is performed on the other CDAC.

During sub-period t1, shared capacitors 3803 and 3804 are coupled to ITVs 3823 and 3824 and bitlines IW1+ and IW1− are sampled and held in CDAC 3829.

During sub-period t2, shared capacitors 3803 and 3804 are coupled to ITVs 3825 and 3826 and bitlines IW2+ and IW2− are sampled and held in CDAC 3830. SAR ADC 3827 performs a conversion operation on the value stored in CDAC 3829 during sub-period t1.

During sub-period t3, shared capacitors 3803 and 3804 are coupled to ITVs 3827 and 3828 and bitlines IW3+ and IW3− are sampled and held in CDAC 3829. SAR ADC 3828 performs a conversion operation on the value stored in CDAC 3830 during sub-period t2.

During sub-period t4, shared capacitors 3803 and 3804 are coupled to ITVs 3827 and 3828 and bitlines IW4+ and IW4− are sampled and held in CDAC 3830. SAR ADC 3827 performs a conversion operation on the value stored in CDAC 3829 during sub-period t3.

During sub-period t5, SAR ADC 3828 performs a conversion operation on the value stored in CDAC 3830 during sub-period t4.

FIG. 39D depicts timing diagram 3950 for operating output circuit 3890 in FIG. 38D, which contains four ITVs selectively coupled to 8 different bit lines and two SAR ADCs. Timing diagram 3950 utilizes a bitline current overlapping technique to reduce settling time. For example, after the output conversion for bitlines IW1+ and IW1−, bitlines IW2+ and IW2− are enabled while bitlines IW1+ and IW1− are still enabled before disabling bitlines IW+ and IW− and starting the conversion process for the bitlines IW2+ and IW2−. This ensures efficient current loading into the ITVs between read operations across multiple bitlines. This is useful for situations where an ITV is shared by multiple bit lines.

During sub-period t1, bitlines IW1+ and IW1− are enabled, shared capacitors 3803 and 3804 are coupled to ITVs 3823 and 3824, bitlines IW1+ and IW1− are sampled and held in CDAC 3829, and SAR ADC 3827 performs a conversion operation on the value stored in CDAC 3829. After the conversion operation, IW2+ and IW2− are enabled while IW1+ and IW1− are still enabled.

During sub-period t2, bitlines IW2+ and IW2− are enabled, shared capacitors 3803 and 3804 are coupled to ITVs 3825 and 3826, bitlines IW2+ and IW2− are sampled and held in CDAC 3830, and SAR ADC 3828 performs a conversion operation on the value stored in CDAC 3830. After the conversion operation, IW3+ and IW3− are enabled while IW2+ and IW2− are still enabled.

During sub-period t3, bitlines IW3+ and IW3− are enabled, shared capacitors 3803 and 3804 are coupled to ITVs 3823 and 3824, bitlines IW3+ and IW3− are sampled and held in CDAC 3829, and SAR ADC 3827 performs a conversion operation on the value stored in CDAC 3829. After the conversion operation, IW4+ and IW4− are enabled while IW3+ and IW3− are still enabled.

During sub-period t4, bitlines IW4+ and IW4− are enabled, shared capacitors 3803 and 3804 are coupled to ITVs 3825 and 3826, bitlines IW4+ and IW4− are sampled and held in CDAC 3830, and SAR ADC 3828 performs a conversion operation on the value stored in CDAC 3829.

In another example, current steering techniques are used in which there is efficient current loading (e.g., from a fixed supply) for the ITV circuits during switching between output operations (current to voltage conversion) for the ITV such as across multiple bit-lines.

Alternatively, a pre-charge current can be enabled on each bitline before the sampling period for all schemes described herein. This helps to ensure the bitline is ramping up from a low voltage to high voltage during the settling period.

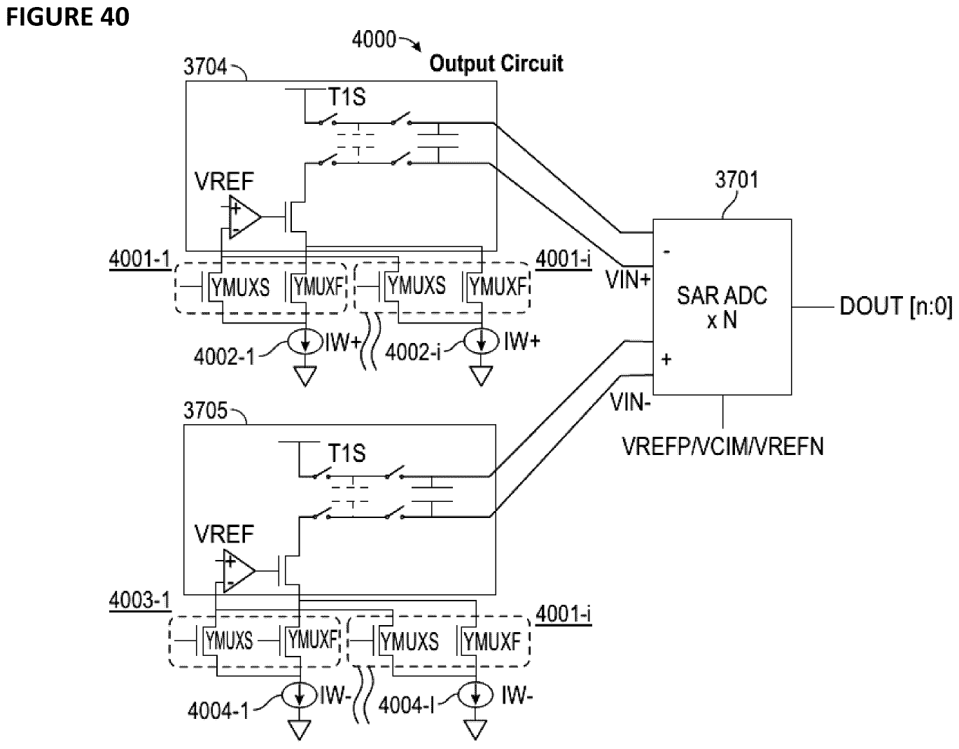

FIG. 40 depicts output circuit 4000, which can be used for i instantiations of column circuit 3502 of FIG. 35. Output circuit 4000 comprises SAR ADC 3701 (or any type of ADC architecture), ITV 3704 for column W+, and ITV 3705 for column W− as in output circuit 3700 described previously for FIG. 37. Unlike output circuit 3700, output circuit 4000 can selectively connected to one of i different W+ current sources (current sources 4002-1, . . . 4002-i) by portions 4001-1, . . . , 4001-i of a column multiplexor and to one of i different W− current sources (current sources 4004-1, . . . , 4004-i) by portions 4003-1, . . . , 4003-i of a column multiplexor. One pair of columns (one W+ column and one W−) are connected to ITV 3704 for column W+, and ITV 3705 for column W− at any given time and all other columns are disconnected from ITV 3704 and ITV 3705 using the multiplexor. Thus, i different W+/W− column pairs share ITVs 3704 and 3705 and SAR ADC 3701. The bitline current switching can be performed using one or more of a current steering technique and a bitline current overlapping technique as described above with reference to FIGS. 39C and 39D.

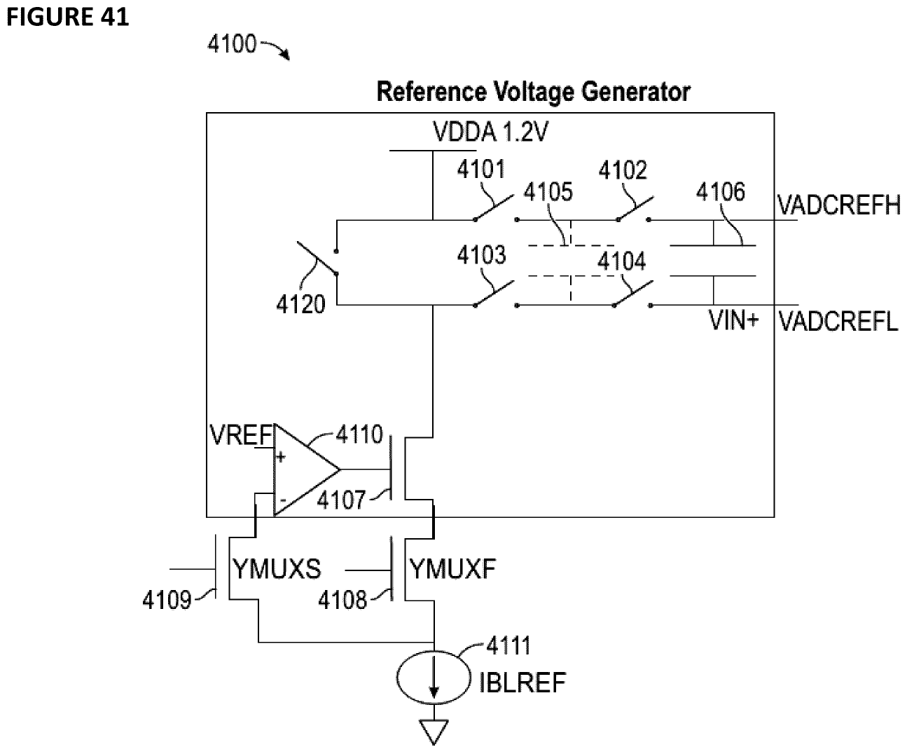

FIG. 41 depicts reference voltage generator 4100 to generate VADCREFL and VADCREFH, which are used to generate voltages VREFP, VCIM, and VREFN that are reference voltages used by SAR ADC 3701 as shown in previous figures. Reference voltage generator 4100 is a current-to-voltage converter similar to that shown in FIG. 37 and converts a reference current, IBLREF, into voltages VADCREFH and VADCREFL. Reference voltage generator 4100 comprises switches 4101, 4102, 4103, 4104, and 4120; capacitors 4105 and 4106; transistor 4107; operational amplifier 4110; transistors 4108 and 4109; and reference current source 4111.

First, switches 4120, 4101, 4102, 4103, and 4104 are closed, resulting in the top and bottom plates of capacitors 4105 and 4106 being charged to VDDA.

Next, switch 4120 is opened. Reference current source 4111 draws a reference current IBLREF, resulting in VADCREFL being pulled downward in proportion to the current drawn by reference current source 4111.

Operational amplifier 4110 and transistors 4107, 4108, and 4109 imposes VREF, which is applied to the positive input terminal of operational amplifier 3714, on the bit line during a read operation irrespective of the magnitude of the current drawn by bit line IW+. FIG. 42 depicts SAR ADC 4200 that is an example of an SAR ADC that can be used for SAR ADC 3701 in FIG. 37; SAR ADCs 3827 and 3828 in FIG. 38A; SAR ADCs 3861, 3862, 3863, and 3864 in FIG. 38B; SAR ADCs 3883 and 3884 in FIG. 38C; SAR ADCs 3827 and 3828 in FIG. 38D; and SAR ADC 3701 in FIG. 40. SAR ADC 4200 comprises CDAC 4201 (which is an example of CDACs 3829, 3830, 3865, 3866, 3867, 3868, 3885, 3886, 3829, and 3830 in FIGS. 37, 38A, 38B, 38C, 38D, and 40), comparator 4202, SAR logic 4203, switch 4204, and switch 4205. Part or all of CDAC 4201 optionally, when not performing an operation in SAR ADC 3701, can be used as capacitors 3803 and 3804 in FIG. 38A, capacitors 3871 and 3872 in FIGS. 38B and 38C, and capacitors 3803 and 3804 in FIG. 38D.

SAR ADC 4200 operates by first sampling the input voltages VIN+ and VIN− into the capacitor array (CDAC) 4201P and 4201N, respectively. SAR logic 4203 will successively convert the voltages into digital bits, starting with the most significant bit and ending with the least significant bit. For example, for an 8-bit ADC, B7 will be converted first and B0 will be converted last. Hence, there are 8 conversion clocks for an 8-bit ADC. For each conversion, the VIN+ will be compared against VIN−, and the comparison decision is used to switch the capacitors associated with the bit for the next bit comparison.

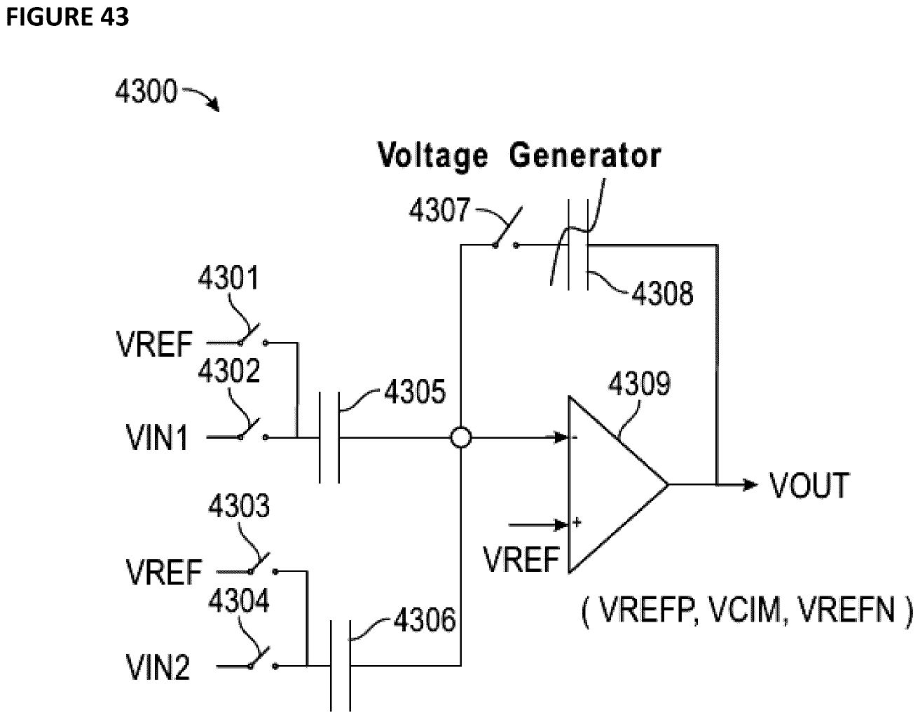

FIG. 43 depicts voltage generator 4300 that can be used to generate VREFP, VREFN, and VCM that are used by SAR ADC 4200 in FIG. 42. Voltage generator 4300 comprises switches 4301, 4302, 4303, and 4304; capacitors 4305 and 4306; switch 4307; variable capacitor 4308; and comparator 4309. In this example, the capacitance of capacitor 4305=the capacitance of capacitor 4306. VOUT=(VIN2−VIN1)*(capacitance of capacitor 4305)/(capacitance of capacitor 4306) by switching the switches 4301 to 4304 appropriately. For example, to generate VREFP (where VOUT will be the value used for VREFP), VADCREFH from FIG. 41 is used for VIN1 and VADCREFL from FIG. 41 is used for VIN2. Variable capacitor 4308 can be adjusted to generate VREFN and VCM.

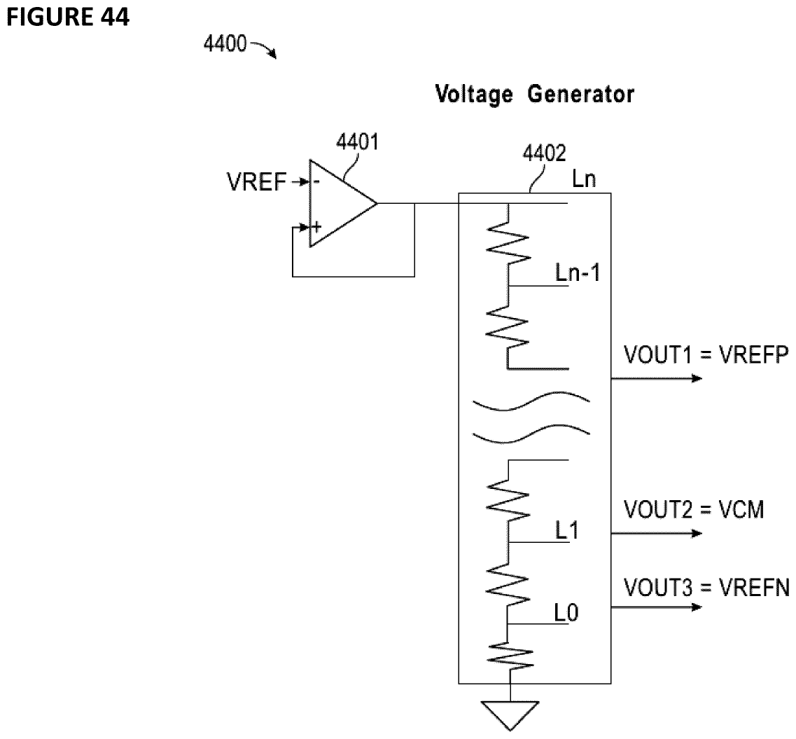

FIG. 44 depicts voltage generator 4400 that can be used to generate VREFP, VREFN, and VCM that are used by SAR ADC 4200 in FIG. 42. Voltage generator 4400 comprises clamp 4401 and resistor ladder 4402. Resistor ladder 4402 comprises n+1 resistors coupled in series. Each node will have a different voltage, ranging from VREF at the top node of resistor ladder 4402 to ground at the bottom node of resistor ladder 4402. Appropriate nodes are selected to provide voltages VREFP, VREFN, and VCM for SAR ADC 4200.

As used herein, the terms “over” and “on” both inclusively include “directly on” (no intermediate materials, elements or space disposed therebetween) and “indirectly on” (intermediate materials, elements or space disposed therebetween). Likewise, the term “adjacent” includes “directly adjacent” (no intermediate materials, elements or space disposed therebetween) and “indirectly adjacent” (intermediate materials, elements or space disposed there between), “mounted to” includes “directly mounted to” (no intermediate materials, elements or space disposed there between) and “indirectly mounted to” (intermediate materials, elements or spaced disposed there between), and “electrically coupled” includes “directly electrically coupled to” (no intermediate materials or elements there between that electrically connect the elements together) and “indirectly electrically coupled to” (intermediate materials or elements there between that electrically connect the elements together). For example, forming an element “over a substrate” can include forming the element directly on the substrate with no intermediate materials/elements therebetween, as well as forming the element indirectly on the substrate with one or more intermediate materials/elements there between.

1. A system comprising:
a vector-by-matrix multiplication array comprising non-volatile memory cells arranged into rows and columns, a first set of columns storing W+ weights and a second set of columns storing W− weights; and
an output circuit to receive a first current from a respective column in the first set of columns and a second current from a respective column in the second set of columns and to generate a first voltage and a second voltage, the output circuit comprising:
a first current-to-voltage converter comprising a first integration capacitor to provide the first voltage equal to an initial voltage minus a first discharge value due to the first current; and
a second current-to-voltage converter comprising a second integration capacitor to provide the second voltage equal to the initial voltage minus a second discharge value due to the second current.

2. The system of claim 1, wherein the first integration capacitor is shared in a time-multiplexed manner with a third current-to-voltage converter.

3. The system of claim 2, wherein the second integration capacitor is shared in a time-multiplexed manner with a fourth current-to-voltage converter.

4. The system of claim 1, wherein the first current-to-voltage converter can be disconnected from the respective column in the first set of columns and connected to another column in the first set of columns to receive a third current and to provide a third voltage equal to an initial voltage minus a third discharge value due to the third current.

5. The system of claim 4, wherein the second current-to-voltage converter can be disconnected from the respective column in the second set of columns and connected to another column in the second set of columns to receive a fourth current and to provide a fourth voltage equal to an initial voltage minus a fourth discharge value due to the fourth current.

6. The system of claim 5, comprising an analog-to-digital converter configurable to convert a difference between the first voltage and the second voltage into a digital output and to convert a difference between the third voltage and the fourth voltage into a digital output.

7. The system of claim 6, wherein the analog-to-digital converter is a successive approximation register analog-to-digital converter.

8. The system of claim 7, wherein the successive approximation register analog-to-digital converter comprises a binary capacitor array (CDAC) configurable to store (i) the first voltage and the second voltage, or (ii) the third voltage and the fourth voltage.

9. The system of claim 1, wherein the first integration capacitor performs a function in an analog-to-digital converter.

10. The system of claim 9, wherein the second integration capacitor performs a function in an analog-to-digital converter.

11. The system of claim 1, comprising:
an analog-to-digital converter to convert a difference between the first voltage and the second voltage into a digital output.

12. The system of claim 11, wherein the analog-to-digital converter is a successive approximation register analog-to-digital converter.

13. The system of claim 1, comprising:
a column multiplexor to couple a column in the first set of columns to the first current-to-voltage converter and to couple a column in the second set of columns to the second current-to-voltage converter.

14. A system comprising:
a vector-by-matrix multiplication array comprising non-volatile memory cells arranged into rows and columns, a first set of columns storing W+ weights and a second set of columns storing W− weights; and
an output circuit to receive a first current from a first column in the first set of columns and a second current from a second column in the second set of columns and to generate a first voltage representing the first current and a second voltage representing the second current and to receive a third current from a third column in the first set of columns, and a fourth current from a fourth column in the second set of columns and to generate a third voltage representing the third current and a fourth voltage representing the fourth current, the output circuit comprising:
a first current-to-voltage converter selectively coupled to a first integration capacitor to provide the first voltage equal to an initial voltage minus a first discharge value due to the first current;
a second current-to-voltage converter selectively coupled to a second integration capacitor to provide the second voltage equal to the initial voltage minus a second discharge value due to the second current;
a third current-to-voltage converter selectively coupled to the first integration capacitor to provide the third voltage equal to the initial voltage minus a third discharge value due to the third current; and
a fourth current-to-voltage converter selectively coupled to the second integration capacitor to provide the fourth voltage equal to the initial voltage minus a fourth discharge value due to the fourth current.

15. The system of claim 14, comprising:
a first analog-to-digital converter to convert a difference between the first voltage and the second voltage into a first digital output.

16. The system of claim 15, wherein the first analog-to-digital converter is a successive approximation register analog-to-digital converter.

17. The system of claim 15, comprising:
a second analog-to-digital converter to convert a difference between the third voltage and the fourth voltage into a second digital output.

18. The system of claim 17, wherein the second analog-to-digital converter is a successive approximation register analog-to-digital converter.

19. A method comprising:
during a first time period:
coupling a first shared capacitor and a second shared capacitor to a first current-to-voltage converter coupled to a first bitline of an array of non-volatile memory cells and a second current-to-voltage converter coupled to a second bitline of the array to generate a first voltage and a second voltage; and
storing the first voltage and the second voltage in first analog-to-digital converter;
during a second time period:
coupling the first shared capacitor and the second shared capacitor to a third current-to-voltage converter coupled to a third bitline of the array and a fourth current-to-voltage converter coupled to a fourth bitline of the array to generate a third voltage and a fourth voltage; and
storing the third voltage and the fourth voltage in a second analog-to-digital converter; and
during a third time period:
converting by the first analog-to-digital converter the first voltage and the second voltage into a first digital output; and
converting by the second analog-to-digital converter the third voltage and the fourth voltage into a second digital output.

20. A method comprising:
receiving by a first current-to-voltage converter, a second current-to-voltage converter, a third current-to-voltage converter, and a fourth current-to-voltage converter current from respective bitlines of an array of non-volatile memory cells;
during a first time period, sampling and holding by a first analog-to-digital converter a first set of voltages received from the first current-to-voltage converter and the second current-to-voltage converter; and
during a second time period, converting, by the first analog-to-digital converter, the first set of voltages into digital outputs and sampling and holding by a second analog-to-digital converter a second set of voltages received from the third current-to-voltage converter and the fourth current-to-voltage converter.

21. A method comprising:
receiving by a first current-to-voltage converter, a second current-to-voltage converter, a third current-to-voltage converter, and a fourth current-to-voltage converter current from respective bitlines of an array of non-volatile memory cells;
during a first time period:
sampling and holding by a first analog-to-digital converter a first set of voltages received from the first current-to-voltage converter and the second current-to-voltage converter; and
converting, by the first analog-to-digital converter, the first set of voltages into digital outputs; and
during a second time period:
sampling and holding by a second analog-to-digital converter a second set of voltages received from the third current-to-voltage converter and the fourth current-to-voltage converter; and
converting, by the second analog-to-digital converter, the second set of voltages into digital outputs.

22. A system comprising:
a vector-by-matrix multiplication array comprising non-volatile memory cells arranged into rows and columns; and
an output circuit to receive a first current from a first column in the vector-by-matrix multiplication array and a second current from a second column in the vector-by-matrix multiplication array, the output circuit comprising:
a first current-to-voltage converter comprising a first integration capacitor to provide a first voltage equal to an initial voltage minus a first discharge value due to the first current; and
a second current-to-voltage converter comprising a second integration capacitor to provide a second voltage equal to the initial voltage minus a second discharge value due to the second current.

23. The system of claim 22, wherein the first integration capacitor is shared in a time-multiplexed manner with a third current-to-voltage converter.

24. The system of claim 23, wherein the second integration capacitor is shared in a time-multiplexed manner with a fourth current-to-voltage converter.

25. The system of claim 22, wherein the first current-to-voltage converter can be disconnected from the first column and connected to a third column in the vector-by-matrix multiplication array to receive a third current and to provide a third voltage equal to an initial voltage minus a third discharge value due to the third current.

26. The system of claim 25, wherein the second current-to-voltage converter can be disconnected from the second column and connected to a fourth column in the vector-by-matrix multiplication array to receive a fourth current and to provide a fourth voltage equal to an initial voltage minus a fourth discharge value due to the fourth current.

27. The system of claim 26, comprising:
a column multiplexor to couple the first column or the third column to the first current-to-voltage converter and to couple the second column or the fourth column to the second current-to-voltage converter.

28. The system of claim 26, comprising:
an analog-to-digital converter configurable to convert a difference between the first voltage and the second voltage into a digital output and to convert a difference between the third voltage and the fourth voltage into a digital output.

29. The system of claim 28, wherein the analog-to-digital converter is a successive approximation register analog-to-digital converter.

30. The system of claim 29, wherein the successive approximation register analog-to-digital converter comprises a binary capacitor array (CDAC) configurable to store (i) the first voltage and the second voltage, or (ii) the third voltage and the fourth voltage.

31. The system of claim 22, wherein the first integration capacitor performs a function in an analog-to-digital converter.

32. The system of claim 31, wherein the second integration capacitor performs a function in an analog-to-digital converter.

33. The system of claim 22, comprising:
an analog-to-digital converter to convert a difference between the first voltage and the second voltage into a digital output.

34. The system of claim 33, wherein the analog-to-digital converter is a successive approximation register analog-to-digital converter.
